(19) United States
(12) Patent Application Publication
(10) Pub. No.: US 2008/0278848 A1
(43) Pub. Date: Nov. 13, 2008

(54) Magnetic recording/reproducing device

(75) Inventors: Hirofumi Asai, Atsugi-Shi (JP); Takuro Negi, Atsugi-Shi (JP); Ryoichi Annen, Atsugi-Shi (JP); Kazuya Tamura, Atsugi-Shi (JP)

Correspondence Address: IPUSA, P.L.L.C, 1054 31ST STREET, N.W., Suite 400, Washington, DC, 20007, US

(73) Assignee: MITSUMI ELECTRIC CO., LTD.

(21) Appl. No.: 12/149,122

(22) Filed: Apr. 28, 2008

(30) Foreign Application Priority Data
May 11, 2007 (JP) 2007-126810

(51) Int. Cl. G11B 5/008

(52) U.S. Cl. 360/93

(57) ABSTRACT

In a magnetic recording/reproducing device, a tape guide member draws out a magnetic tape from a tape cassette to form a tape path in a vicinity of a magnetic head, and a tape guide moving mechanism moves the tape guide member. The tape guide moving mechanism includes a driving force transmitting member which transmits a driving force from a drive source, and an arm member which supports the tape guide member and is arranged so that the arm member is rotated in accordance with an action of the driving force transmitting member. A hooking member is interlocked with the action of the driving force transmitting member and hooks the tape guide member after the arm member is rotated to a position where the tape path is formed.

### BACKGROUND OF THE INVENTION

1. Field of the Invention

This invention relates to a magnetic recording/reproducing device, and more particularly to a magnetic recording/reproducing device wherein, when a tape cassette is attached, a tape loading mechanism draws out a magnetic tape wound around the reel in the tape cassette and arranges the magnetic tape around the rim of a rotary drum so that magnetic recording or magnetic reproducing of the magnetic tape is performed while the magnetic tape is rotated on the rotary drum.

2. Description of the Related Art

A magnetic recording/reproducing device includes a rotary drum and a tape loading mechanism, and this magnetic recording/reproducing device is used, for example, as an external storage device (streamer device) of a computer. The magnetic recording/reproducing device of this type is arranged so that one of the tape cassettes of different kinds, each containing a magnetic tape having a tape width different from that of another magnetic tape, may be selectively attached to the magnetic recording/reproducing device. A tape loading mechanism draws out the magnetic tape, wound around the reel in the attached tape cassette, and arranges the magnetic tape around the rim of a rotary drum. This tape loading mechanism is operated based on a detection signal output from a detection switch which detects a kind of the attached tape cassette. For example, refer to Japanese Laid-Open Patent Application No. 2004-288244.

In a tape loading mechanism of a conventional magnetic recording/reproducing device, a tape guide roller is inserted inside the magnetic tape which is wound between the tape take-up reel and the tape supply reel in the tape cassette. The magnetic tape is drawn out from the tape cassette by rotating the tape guide roller supporting arm which is arranged to support the tape guide roller at one end thereof. The magnetic tape, drawn out from the tape cassette by the tape guide roller, forms a part of a tape path in which the magnetic tape is wound around the rim of the rotary drum in a range of a predetermined rotation angle by a tape loading member which is subsequently operated.

A back tension (tensile force) is given to the magnetic tape by the tape guide roller on the tape supply side of the rotary drum, and the magnetic tape is placed on the capstan on the tape take-up side of the rotary drum under pressure by a pinch roller, and a driving force in the take-up direction is given to the magnetic tape. By rotation of the rotary drum, the magnetic tape runs in the take-up direction. While the magnetic tape is running in the take-up direction, magnetic recording or magnetic reproducing of the magnetic tape is carried out by a helical scan method.

The above-mentioned conventional magnetic recording/reproducing device is arranged so that, if a tape cassette is attached and a slide operation of a slide lever of the tape loading mechanism is performed, a drive pin which is raised by the slide lever is brought into contact with a projection which projects from the other end of the tape guide roller supporting arm to rotate the tape guide roller supporting arm in the tape draw-out direction.

However, when the tape guide roller supporting arm is held in the tape loading location, the above-mentioned conventional magnetic recording/reproducing device uses a spring force of a torsion spring as the holding force. When the tape loading action is completed, one end of the tape guide roller supporting arm is in contact with a stopper pin fixed to the chassis, and the drive pin presses the tape guide roller supporting arm through the spring force of the torsion spring. The spring force of the torsion spring acts as the holding force against the tensile force of the magnetic tape which slides on the tape guide roller.

Meanwhile, in order to stabilize fluctuations of the tape tension caused by dimensional variations of the respective component parts which constitute the tape loading mechanism, it is necessary that the magnetic recording/reproducing device has an increased holding force of the tape guide roller.

A conceivable method of increasing the holding force of the tape guide roller is to use a torsion spring having a larger spring constant in order to actuate the tape guide roller supporting arm.

However, if the spring force of the spring which actuates the tape guide roller supporting arm is increased, a frictional force produced between the drive pin and the tape guide roller supporting arm is also increased. For this reason, the sliding resistance in the sliding contact portion between the drive pin and the tape guide roller supporting arm is increased, which causes difficulty in attaining a smooth tape loading action.

On the other hand, if the spring constant is set up to a level appropriate for attaining a smooth tape loading action, it may be difficult to secure an adequate holding force of the tape guide roller.

### SUMMARY OF THE INVENTION

In one aspect of the invention, the present disclosure provides an improved magnetic recording/reproducing device in which the above-described problems are eliminated.

In an embodiment of the invention which solves or reduces one or more of the above-mentioned problems, a magnetic recording/reproducing device is provided which includes: a rotary drum device having a magnetic head which performs magnetic recording and magnetic reproducing of a magnetic tape; a tape guide member drawing out a magnetic tape from a tape cassette to form a tape path in a vicinity of the magnetic head; a tape loading member arranging the magnetic tape, drawn out from the tape cassette by the tape guide member, around a rim of the rotary drum device; and a tape guide moving mechanism moving the tape guide member, the tape guide moving mechanism comprising: a driving force transmitting member transmitting a driving force from a drive source; an arm member supporting the tape guide member and being arranged so that the arm member is rotated in accordance with an action of the driving force transmitting member; and a hooking member which is interlocked with the action of the driving force transmitting member and which hooks the tape guide member after the arm member is rotated to a position where the tape path is formed.

The above-mentioned magnetic recording/reproducing device may be configured so that the hooking member is arranged to hook the tape guide member at the position where the tape path is formed, when the arm member is rotated from a tape guide member side to a return direction side.

The above-mentioned magnetic recording/reproducing device may be configured to further comprise: a positioning member which is brought in contact with the arm member when the arm member is rotated to the position where the tape path is formed; and a pressing member which presses the arm member to the positioning member in accordance with a sliding operation of the driving force transmitting member after the arm member contacts the positioning member.

The above-mentioned magnetic recording/reproducing device may be configured so that a location in the rotation direction of the arm member and a location in the vertical direction of the arm member are determined when the arm member is rotated to the position where the tape path is formed.

According to the embodiments of the invention, it is possible to provide a magnetic recording/reproducing device which is arranged so that a hooking member is interlocked with the action of a driving force transmitting member after an arm member is rotated to a position where a tape path is formed, and the hooking member is rotated to hook a tape guide member. It is possible for the magnetic recording/reproducing device to hold the tape guide member firmly against the tape tension. Even if the tape tension changes, loose fitting of the tape guide member is prevented, the running condition of the magnetic tape can be stabilized, and magnetic recording and magnetic reproducing by the rotary head of the rotary drum device can be stabilized. Without increasing the spring force to actuate the arm member, the tape guide member is held when the arm member is rotated to the tape path formation position by the slide operation of the driving member, and it is possible to avoid the defective tape loading action of the arm member due to an increased spring force.

### BRIEF DESCRIPTION OF THE DRAWINGS

Other objects, features and advantages of the invention will be apparent from the following detailed description when read in conjunction with the accompanying drawings.

FIG. 1 is a perspective view showing the composition of a streamer device in which a magnetic recording/reproducing device in an embodiment of the invention is incorporated.

FIG. 2 is a top view of the streamer device of FIG. 1.

FIG. 3 is a diagram for explaining a tape loading action of the streamer device when a current tape cassette is attached.

FIG. 4 is a diagram for explaining a tape loading action of the streamer device when a new tape cassette is attached.

FIG. 5 is a diagram showing the condition of the streamer device in which the tape loading from the current tape cassette is completed.

FIG. 6 is a diagram showing the condition of the streamer device in which the tape loading from the new tape cassette is completed.

FIG. 7A, FIG. 7B and FIG. 7C are diagrams showing the condition of a 4 mm width magnetic tape and an 8 mm width magnetic tape, each wound around a rotary drum device, and showing a track pattern on each magnetic tape.

FIG. 8A and FIG. 8B are diagrams showing the condition of the streamer device in which a current tape cassette is attached.

FIG. 9 is a diagram showing the condition of the streamer device in which the action 121 in FIG. 3 is completed.

FIG. 10 is a diagram showing the condition of the streamer device in which the action 122 in FIG. 3 is completed.

FIG. 11 is a diagram showing the condition of the streamer device in which the action 123 in FIG. 3 is completed.

FIG. 12A and FIG. 12B are diagrams showing the condition of the streamer device in which a new tape cassette is attached.

FIG. 13A and FIG. 13B are diagrams showing the condition of the streamer device in which the action 131 in FIG. 4 is completed.

FIG. 14 is a diagram showing the condition of the streamer device in which the action 132 in FIG. 4 is completed.

FIG. 15 is a diagram showing the condition of the streamer device in which the action 133 in FIG. 4 is in progress.

FIG. 16 is a diagram showing the condition of the streamer device in which the action 133 in FIG. 4 is in progress.

FIG. 17 is a diagram showing the condition of the streamer device in which the action 133 in FIG. 4 is completed.

FIG. 18 is a diagram showing the condition of the streamer device in which the action 134 in FIG. 4 is completed.

FIG. 19 is a perspective view showing the bottom side of a first driving mechanism.

FIG. 20 is a perspective view showing the condition of the pole moving mechanism in which the poles P1 and P9 are in the initial state.

FIG. 21 is a perspective view showing the condition of the pole moving mechanism in which the poles P1 and P9 are moved.

FIG. 22 is a perspective view showing the condition of the pole moving mechanism in which the poles P1, P5(8), P8 and P9 are lowered in the initial state.

FIG. 23 is a perspective view showing the condition of the pole moving mechanism in which the poles P1, P5(8), P8 and P9 are lifted.

FIG. 24 is a diagram showing the condition of the tape guide moving mechanism before the tape loading action is performed.

FIG. 25 is a perspective view showing the condition of the tape guide moving mechanism before the tape loading action is performed.

FIG. 26 is an enlarged perspective view showing the respective members of the tape guide moving mechanism before the tape loading action is performed.

FIG. 27 is a diagram showing the assembly condition of a guide-roller hook unit.

FIG. 28 is an exploded perspective view of the guide-roller hook unit.

FIG. 29 is a diagram showing the mounted condition of a positioning member.

FIG. 30 is a diagram showing the top side of the tape guide moving mechanism when the tape loading action is completed.

FIG. 31 is a diagram showing the bottom side of the tape guide moving mechanism when the tape loading action is completed.

FIG. 32 is a diagram showing the condition of the tape guide moving mechanism in which the arm contacts the positioning member.

FIG. 33 is a diagram showing the condition of the tape guide moving mechanism in which the guide-roller hook hooks the pole P1.

FIG. 34 is a diagram showing the condition of the tape guide moving mechanism in which the guide-roller hook is engaged to the pole P1 by pressure.

### DETAILED DESCRIPTION OF PREFERRED EMBODIMENTS

A description will now be given of embodiments of the invention with reference to the accompanying drawings.

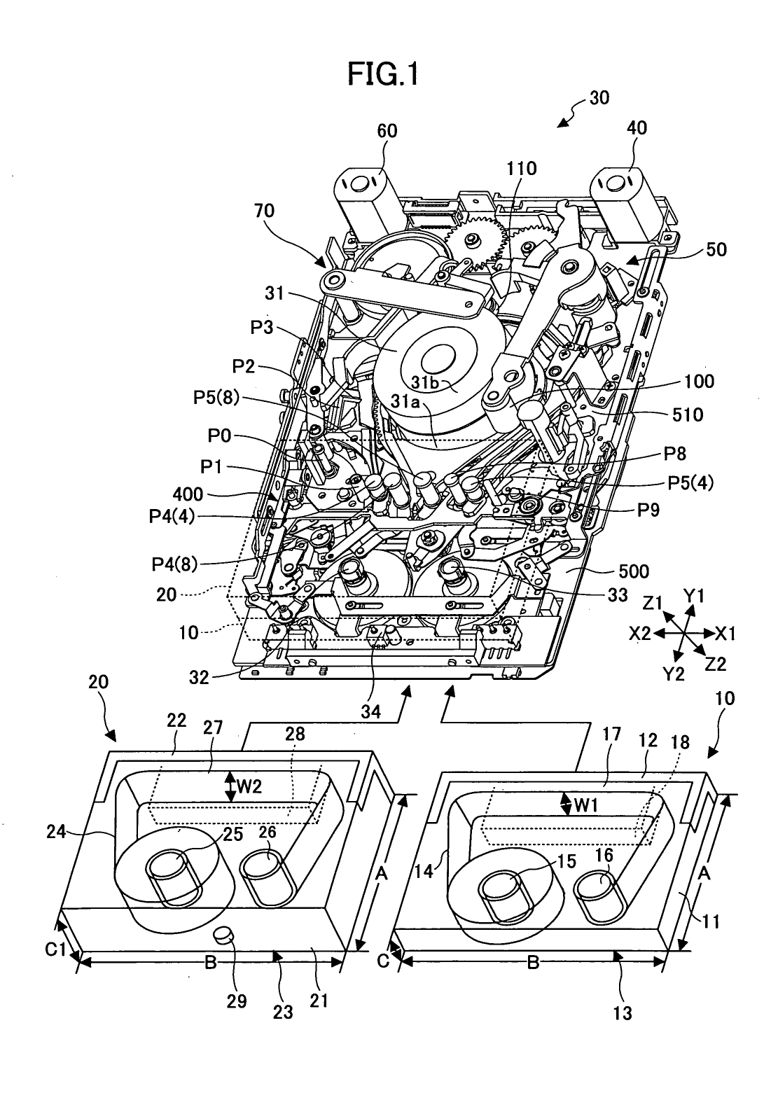

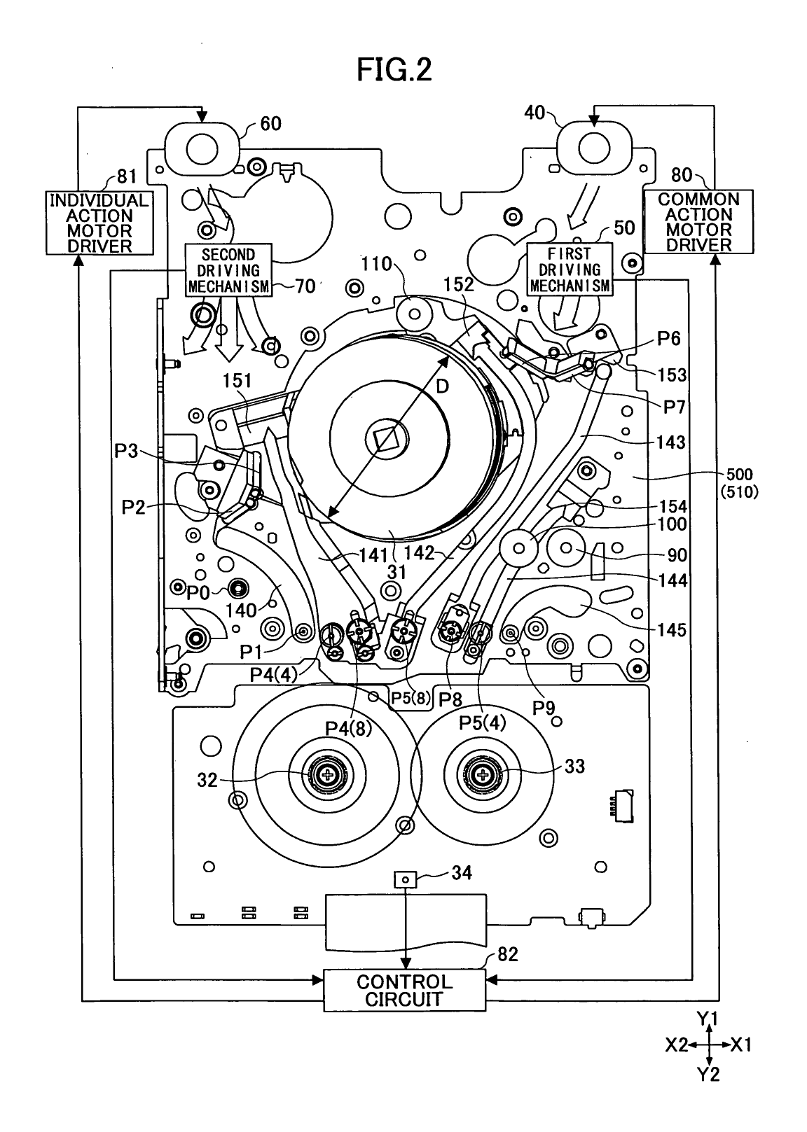

FIG. 1 is a perspective view showing the composition of a streamer device 30 in which a magnetic recording/reproducing device in an embodiment of the invention is incorporated. FIG. 2 is a top view of the streamer device 30 of FIG. 1. In FIG. 2, a main chassis 500 and a sub-chassis 510 are illustrated as if they are located on the same plane for the sake of convenience.

A description will be given of the outline of the streamer device 30. The streamer device 30 of FIG. 1 and FIG. 2 is in the condition before a tape cassette is attached. The arrow X1-X2 indicates a width direction of the streamer device 30, the arrow Y1-Y2 indicates a longitudinal direction of the streamer device 30, and the arrow Z1-Z2 indicates a height direction of the streamer device 30.

The streamer device 30 is arranged so that one of a tape cassette 10 containing a magnetic tape with a width of 4 mm and a tape cassette 20 containing a magnetic tape with a width of 8 mm is selectively attachable. A rotary drum device 31 is arranged so that a drum contact angle of the magnetic tape with the width of 8 mm is larger than a drum contact angle of the magnetic tape with the width of 4 mm.

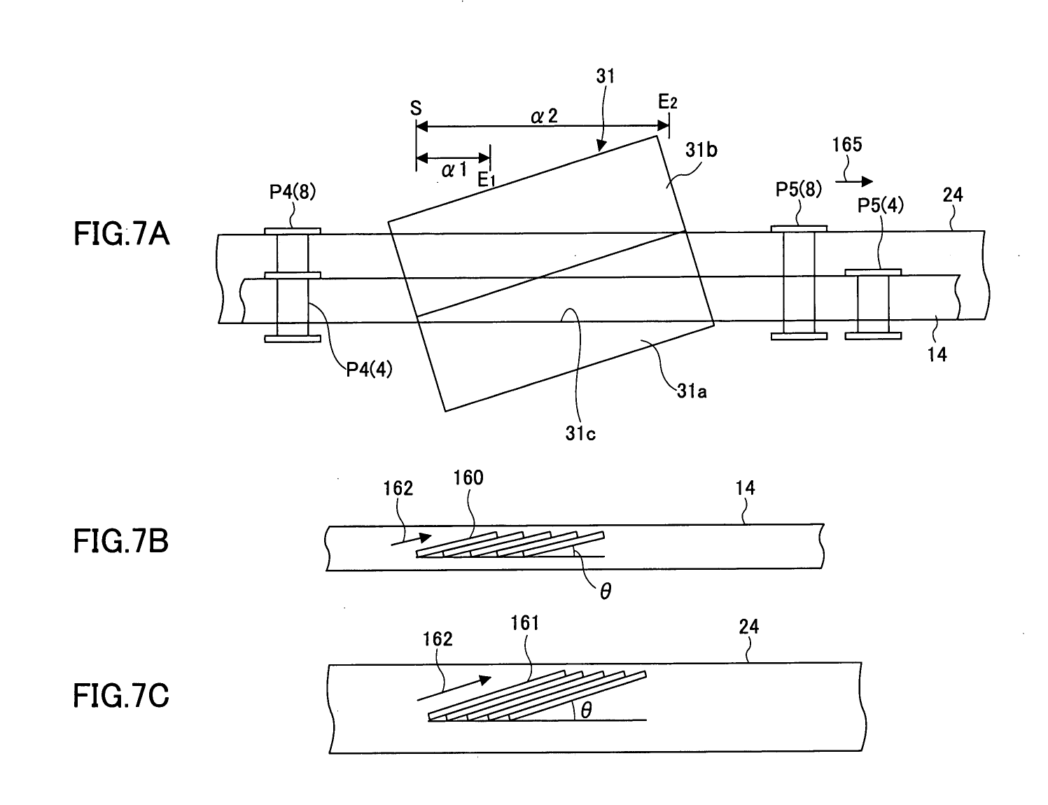

The rotary drum device 31 includes a lower fixed drum 31a and an upper rotary drum 31b, as shown in FIG. 7A. A rotary head is fixed to the bottom surface of the rotary drum, and a tape guide 31c which guides the lowermost edge of a magnetic tape to the fixed drum is formed.

The streamer device 30 includes, on a main chassis 500 and a sub-chassis 510, a cassette mounting mechanism (not shown), a rotary drum device 31 having two or more rotary heads, a common action motor 40, a first driving mechanism 50 which transmits the rotation of the common action motor 40, an individual action motor 60, a second driving mechanism 70 which transmits the clockwise rotation of the individual action motor 60 to the first part and transmits the counterclockwise rotation of the individual action motor 60 to the second part, a common action motor driver 80, an individual action motor driver 81, and a control circuit 82 which is constituted by a microcomputer.

The cassette mounting mechanism includes a housing which is suited to a configuration of the new tape cassette 20. The cassette mounting mechanism is arranged so that one of the current tape cassette 10 and the new tape cassette 20 is selectively attachable.

The main chassis 500 is a base on which the main parts including the rotary drum device 31, the common action motor 40, the individual action motor 60, and the cassette mounting mechanism are supported.

The sub-chassis 510 is supported at a position above the main chassis 500, and the tape loading mechanism and the tape guide moving mechanism 400 are arranged on the sub-chassis 510.

The common action motor 40 is driven when operating a common tape loading mechanism which is associated with both the magnetic tape with the width of 4 mm and the magnetic tape with the width of 8 mm. The rotation of the common action motor 40 is transmitted to the common tape loading mechanism via the first driving mechanism 50, so that the common tape loading mechanism is operated.

The individual action motor 60 is rotated clockwise when operating a 4 mm width tape loading mechanism associated with the magnetic tape whose tape width is 4 mm. The individual action motor 60 is rotated counterclockwise when operating a 8 mm width tape loading mechanism associated with the magnetic tape whose tape width is 8 mm. The clockwise rotation of the individual action motor 60 is transmitted to the 4 mm width tape loading mechanism via the first driving mechanism 50, so that the 4 mm width tape loading mechanism is operated. The counterclockwise rotation of the individual action motor 60 is transmitted to the 8 mm width tape loading mechanism via the second driving mechanism 70, so that the 8 mm width tape loading mechanism is operated.

The streamer device 30 further includes a plurality of loading poles P0-P9 which guide the running of a magnetic tape (which loading poles are also called the poles), a capstan 90, a pinch roller 100, and a head cleaner 110. The poles include: the poles P0, P1, P2, P3, P9 for use in common to the 4 mm and 8 mm wide magnetic tapes; the poles P4(4), P5(4) for exclusive use with the 4 mm wide magnetic tape; and the poles P4(8), P5(8), P6, P7, PB for exclusive use with the 8 mm wide magnetic tape. In this respect, the numbers 4 and 8 in parentheses indicate the width in millimeters of a magnetic tape associated with the pole. The poles P0, P1, P2, and P3 constitute the common tape loading mechanism, the poles P4(4) and P5(4) constitute the 4 mm width tape loading mechanism, and the poles P4(8), P5(8), P6, P7, and P8 constitute the 8 mm width tape loading mechanism.

The poles are classified into the fixed poles P0, P2, P3, P6, P7, and the movable poles P1, P4(4), P4(8), P5(8), P8, P5(4), P9. The pole P0 is arranged on the X2 side of and in the vicinity of the tape cassette mounting part. The poles P2 and P3 which constitute a pair of poles are inclined in the direction in which their upper ends approach each other, and are arranged on the entrance side of the rotary drum device 31 with respect to the running direction of a magnetic tape to give a twist to the magnetic tape. The poles P6 and P7 which constitute a pair of poles are inclined in the direction in which their upper ends are separated from each other, and are arranged on the outlet side of the rotary drum device 31 with respect to the running direction of a magnetic tape to give a twist to the magnetic tape.

The capstan 90 is arranged on the X1 side of and in the vicinity of the tape cassette mounting part. The pinch roller 100 is normally located at a high position and arranged in the vicinity of the capstan 90.

The movable poles P1, P4(4), P4(8), P5(8), P8, P5(4), P9 are arranged in a line in the tape cassette mounting part in this order from the X2 side to the X1 side. Each of the poles P1 (tape guide member), P4(4), P4(8), P5(8), P8, P5(4), and P9 which are moved by the tape loading action is provided with a guide roller which is rotated when the magnetic tape slides on the guide roller.

Among the movable poles P1, P4(4), P4(8), P5(8), P8, P5(4), and P9, the poles P1, P4(8), P5(8), P8, and P9 have a length larger than a length of the poles P4(4) and P5(4). These longer poles P1, P4(8), P5(8), P8, and P9 are in the location which is lowered in the Z2 direction. All the movable poles P1, P4(4), P4(8), P5(8), P8, P5(4), and P9 are arranged so that their upper ends are at the same height. This is because the streamer device is arranged so that the current tape cassette 10 is attached at the height that is the same as that of the new tape cassette 20 and it does not interfere with the pole P1, which will be described later.

Next, a description will be given of the structure of the tape cassettes 10 and 20 with reference to FIG. 1.

In the current tape cassette 10, inside a cassette body 13 which includes a housing 11, a front side lid 12 and a sliding plate (not shown) at the bottom, a magnetic tape 14 is wound around a tape-supply reel 15 and a take-up reel 16, and the magnetic tape 14 is accommodated to form a tape path 17 along the bottom inside surface of the lid 12. The current tape cassette 10 includes a pole accommodating space 18 at the front side part of the bottom which is opened at the time of mounting.

In the new tape cassette 20, inside a cassette body 23 which includes a housing 21, a front side lid 22, and a sliding plate (not shown) at the bottom, a magnetic tape 24 is wound around a tape-supply reel 25 and a take-up reel 26, and the magnetic tape 24 is accommodated to form a tape path 27 along the bottom inside surface of the lid 22. The new tape cassette 20 includes a pole accommodating space 28 at the front side part of the bottom which is opened at the time of mounting. As to the size of the new tape cassette 20, the width A and the length B are the same as those of the current tape cassette 10. The height C1 of the new tape cassette 20 is about 1.5 times as large as the height C of the current tape cassette 10. In the new tape cassette 20, a recess 29 is formed in the center of the bottom end surface of the housing 21.

On the main chassis 500 of the streamer device 30 to which either the current tape cassette 10 or the new tape cassette 20 is attached, a tape-supply reel shaft device 32, a tape-winding shaft device 33, and a tape cassette distinction switch 34 are provided.

The tape cassette mounting mechanism is arranged so that the bottom base of the new tape cassette 20, when it is attached, is at the height that is the same as the height of the bottom base of the current tape cassette 10 when it is attached.

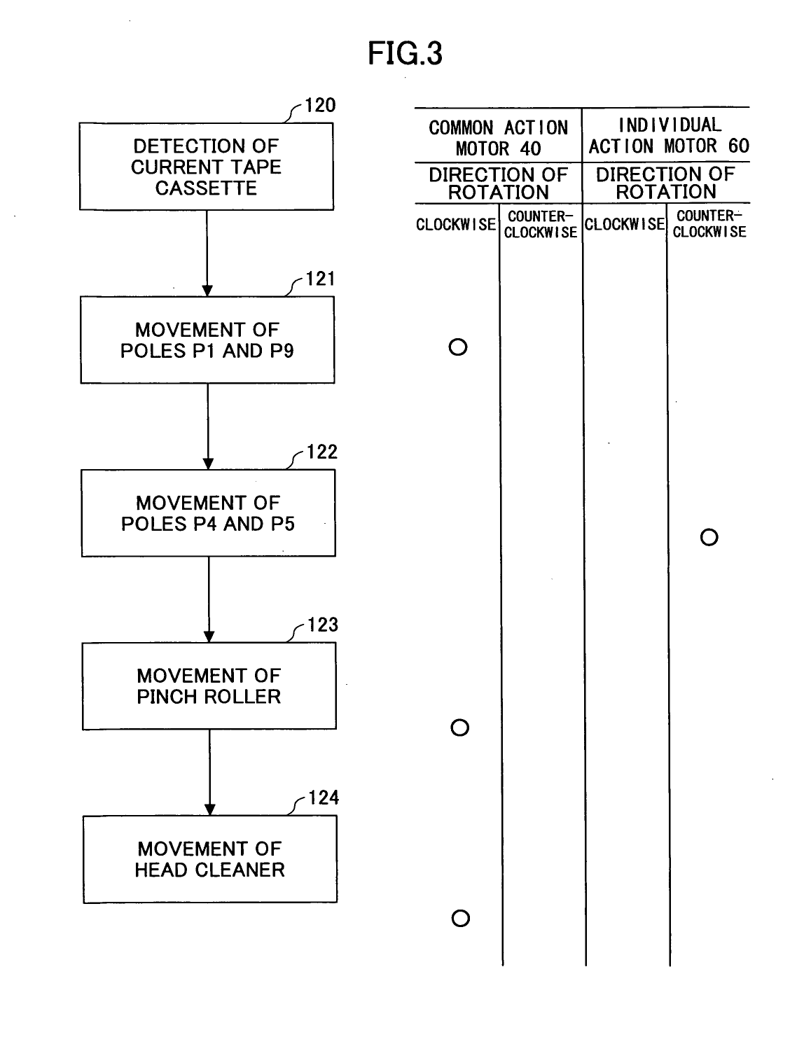

Next, a description will be given of the outline of the tape loading action of the streamer device 30. As shown in FIG. 3, when the current tape cassette 10 is attached, a current tape cassette detection operation 120, a pole P1, P9 movement operation 121, a pole P4(4), P5(4) movement operation 122, a pinch roller movement operation 123, and a head cleaner movement operation 124 are performed in this sequence.

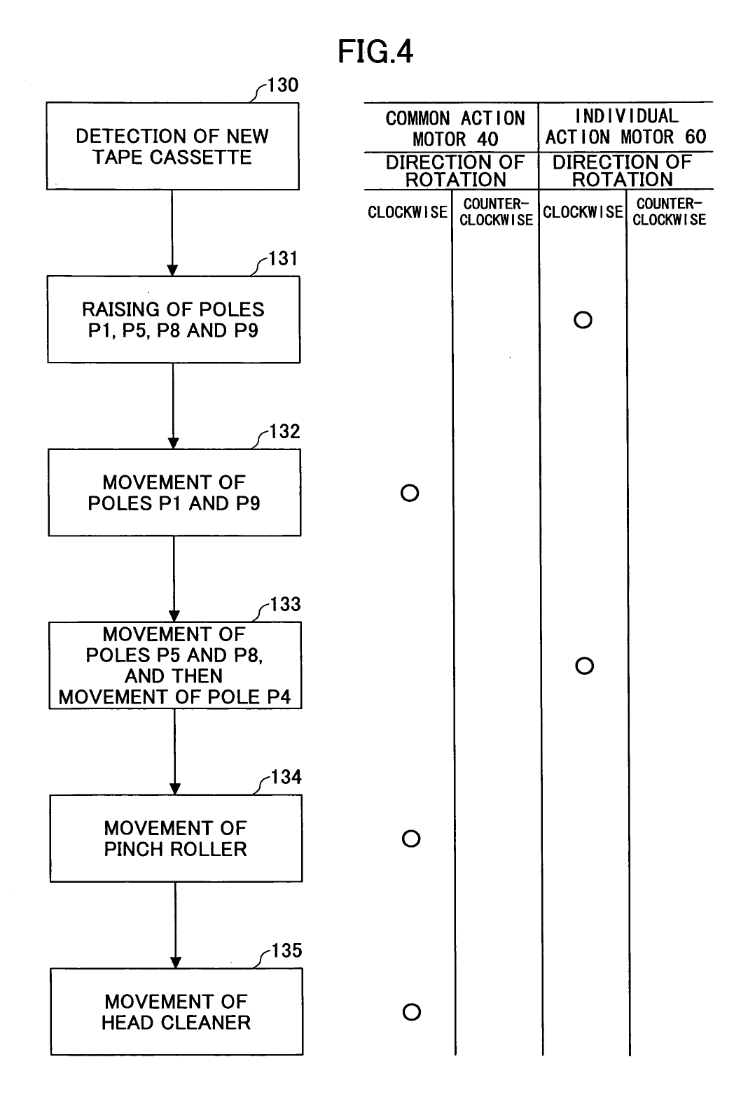

As shown in FIG. 4, when the new tape cassette 20 is attached, a new tape cassette detection operation 130, a pole P1, P5(8), P8, P9 movement operation 131, a pole P1, P9 movement operation 132, a pole P5(8), P8, P4(8) movement operation 133, a pinch roller movement operation 134, and a head cleaner movement operation 135 are performed in this sequence.

The pole P1, P9 movement operations 121 and 131, the pinch roller movement operations 123 and 134, and the head cleaner movement operations 124 and 135 are common actions, and these actions are carried out by the common action motor 40 which is rotated clockwise.

The pole P4(4) and P5(4) movement operation 121 is an individual action specific to the current tape cassette 10. The pole P1, P5(8), P8, P9 movement operation 131 and the pole P5(8), PB, P4(8) movement operation 133 are individual actions specific to the new tape cassette 20. These individual actions are performed by rotating the individual action motor 50. The action 122 which is specific to the current tape cassette 10 is performed by rotating the individual action motor 50 counterclockwise. The actions 131 and action 133 which are specific to the new tape cassette 20 are performed by rotating the individual action motor 50 clockwise contrary to the above. In FIGS. 3 and 4, the circle symbol indicates the motor to be driven and the direction of rotation of the driven motor.

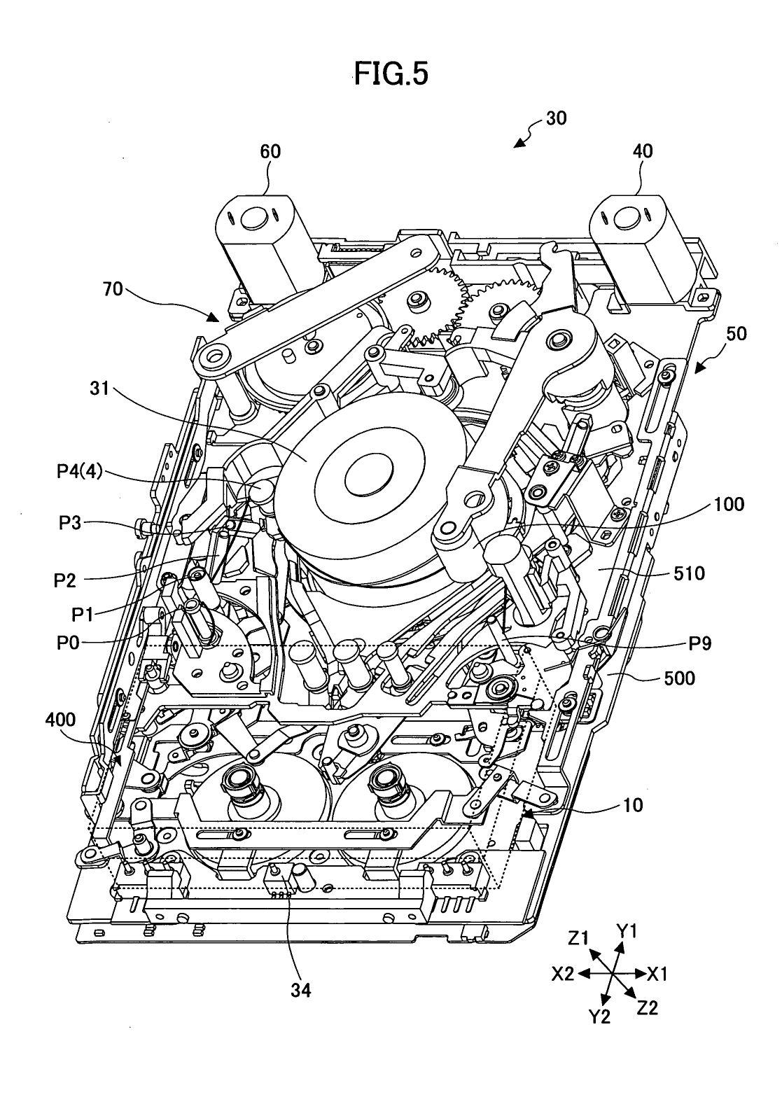

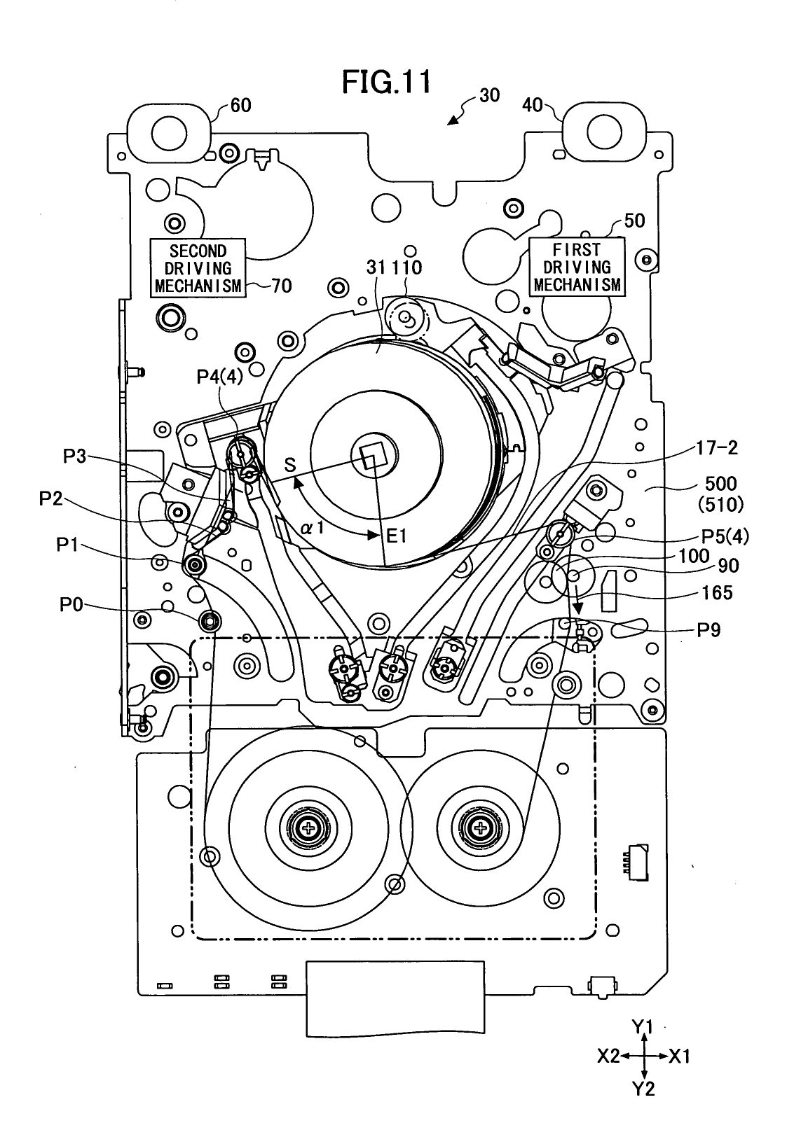

If the current tape cassette 10 is attached and the actions 121, 122, and 123 are performed as shown in FIG. 3, the tape loading is performed and the streamer device 30 is set in the condition shown in FIGS. 5 and 11. In this condition, the magnetic tape 14 forms a tape path 17-2d and, as shown in FIG. 7A, the magnetic tape 14 has the drum contact angle α1 (about 90 degrees) on the rotary drum device 31 from location S to location E1. The magnetic tape 14 is guided by the tape guide 31c and arranged slantingly. As shown in FIG. 7B, the rotary head scans the magnetic tape 14 as indicated by the arrow 162, so that information is recorded as a track pattern 160 whose slanting angle is θ. This track pattern 160 is basically the same as the track pattern by the current streamer device, which ensures the downward compatibility. FIG. 7B shows a track pattern on the side of the magnetic tape 14 opposite to the magnetic layer side when viewed from the Y2 side. The drum contact angle α1 is an angle required to form the track pattern 160 in the whole width of the magnetic tape 14. The arrow 162 indicates the direction in which the rotary head scans the magnetic tape 14.

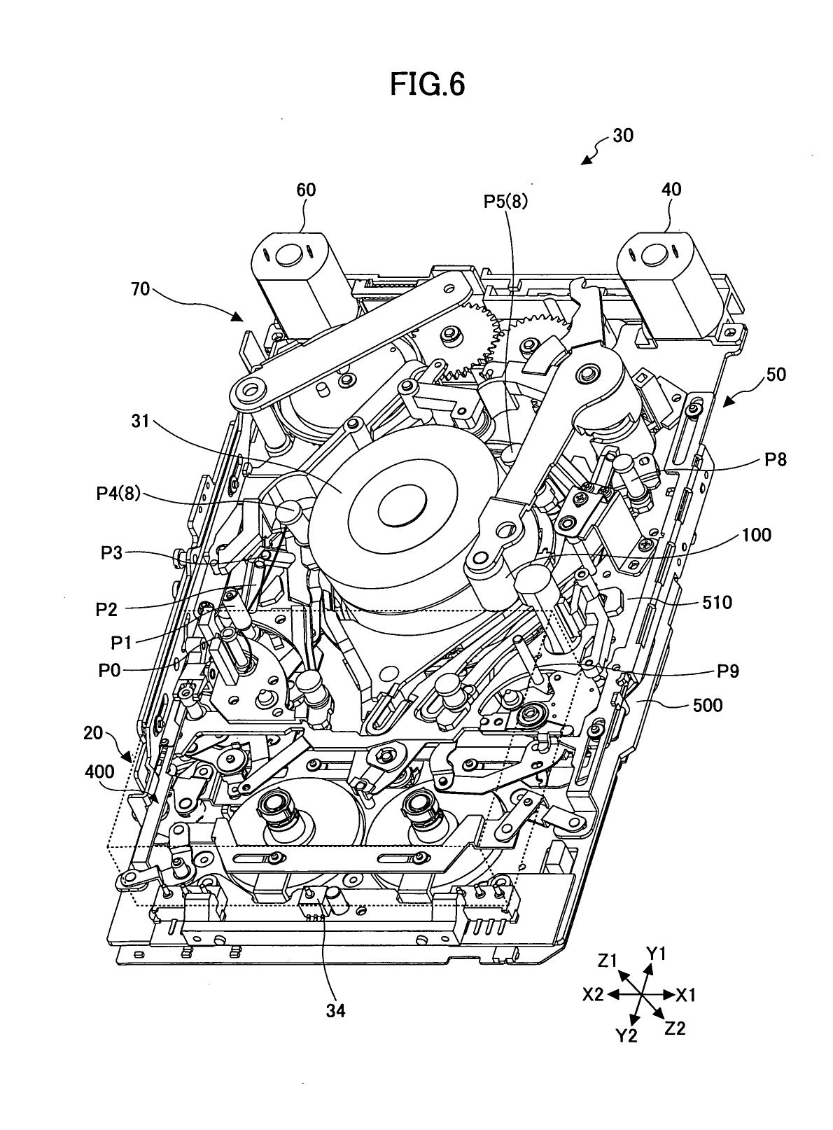

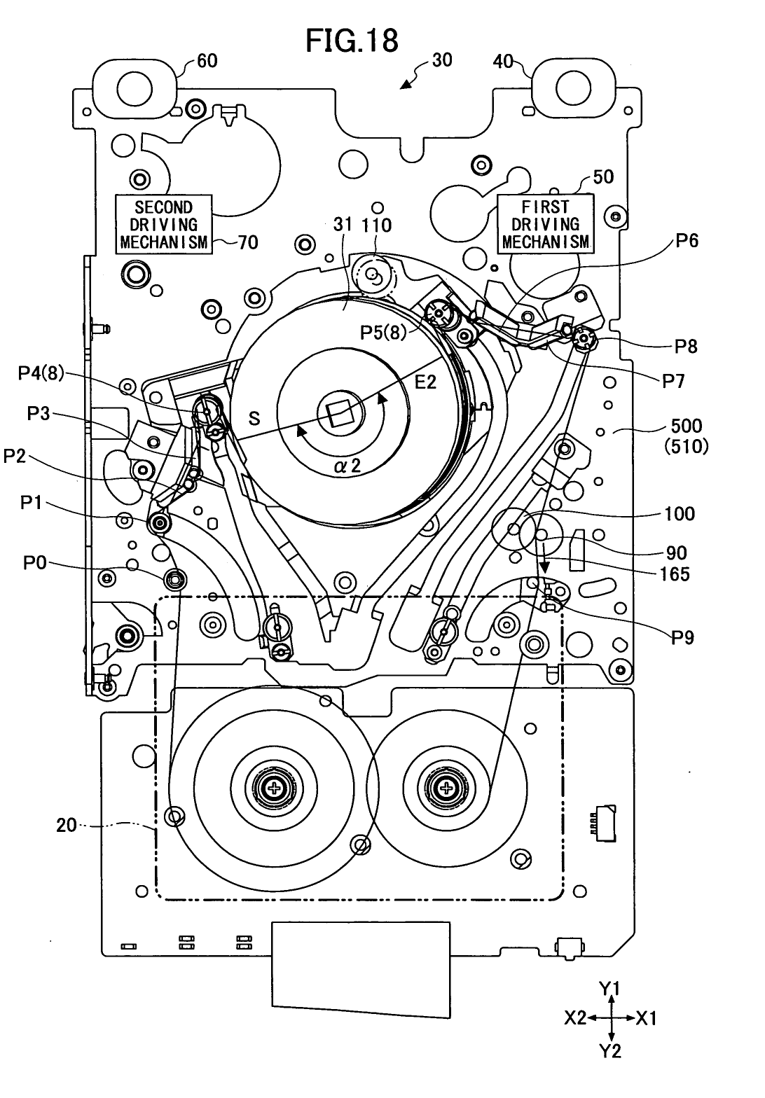

If the new tape cassette 20 is attached and the actions 131, 132, 133, and 134 are performed as shown in FIG. 4, the tape loading is performed and the streamer device 30 is set in the condition as shown in FIGS. 6 and 18. In this condition, the magnetic tape 24 forms a tape path 27-4 and, as shown in FIG. 7A, the magnetic tape 24 has the drum contact angle α2 (about 180 degrees) on the rotary drum device 31 from location S to location E2. The magnetic tape 24 is guided by the tape guide 31c and arranged slantingly. As shown in FIG. 7C, the rotary head scans the magnetic tape 24 as indicated by the arrow 162, so that information is recorded as the track pattern 161. The track pattern 161 is an extended track pattern which is extended from the track pattern 160, and the storage capacity of the magnetic tape 24 is increased remarkably when compared with the current magnetic tape 14. FIG. 7C shows a track pattern on the side of the magnetic tape 24 opposite to the magnetic layer side. The drum contact angle α2 is an angle required to form the track pattern 161 in the whole width of the magnetic tape 24. The starting position S at which the magnetic tape 14 is wound on the rotary drum device 31 is the same as the starting position S at which the magnetic tape 24 is wound on the rotary drum device 31.

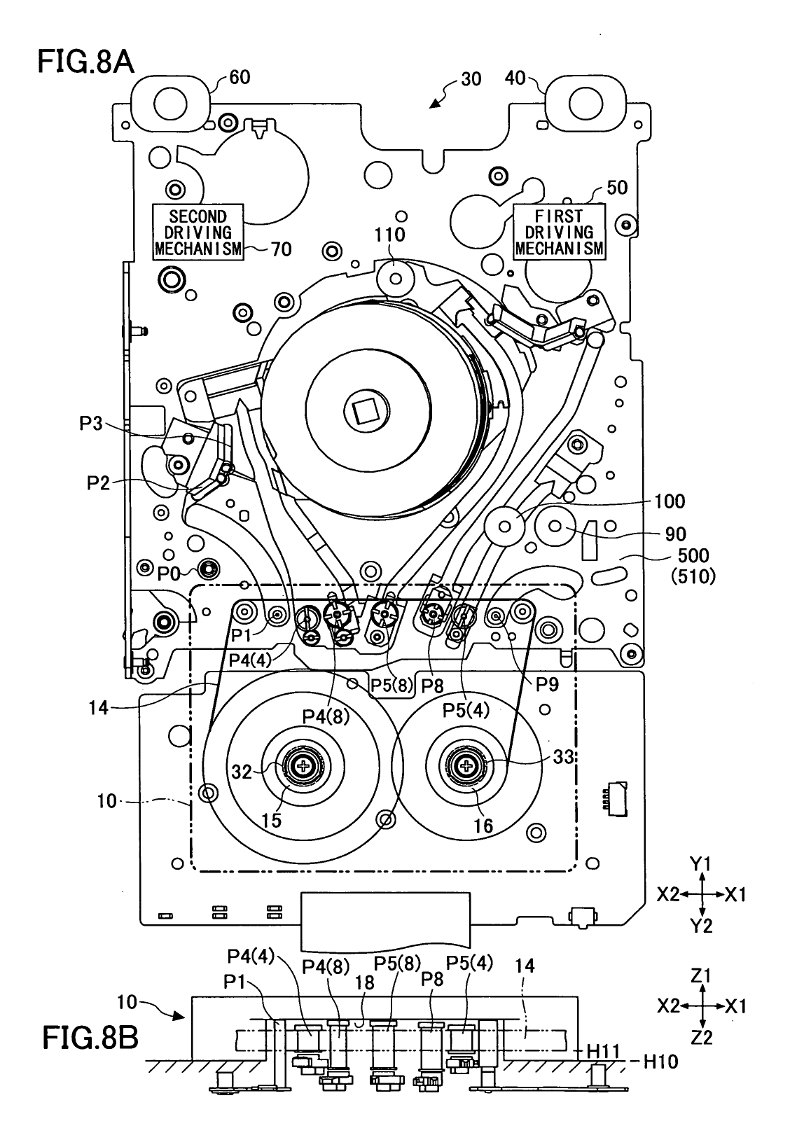

Next, a description will be given of the tape loading which is performed when the current tape cassette 10 is attached with reference to FIGS. 8 to 11. In addition, in FIGS. 8 to 18, it is supposed that the main chassis 500 and the sub-chassis 510 are on the same plane for the sake of convenience.

As shown in FIG. 2, the streamer device 30 includes the passages 140-145 for moving the poles and the stoppers 151, 152, 153, 154. FIG. 8A and FIG. 8B show the condition of the streamer device when the current tape cassette 10 is attached.

The current tape cassette 10 is attached with the bottom base being set at the height H10. The sliding plate (not shown) is moved and the tape-supply reel 15 and the take-up reel 16 are fitted to the tape-supply reel shaft device 32 and the tape-winding shaft device 33, respectively. The lid 12 is opened and the poles P1, P4(4), P4(8), P5(8), P8, P5(4), and P9 enter the pole accommodating space 18. The tape cassette distinction switch 32 is pressed by the cassette body 13, and the current tape cassette detection operation 120 is performed.

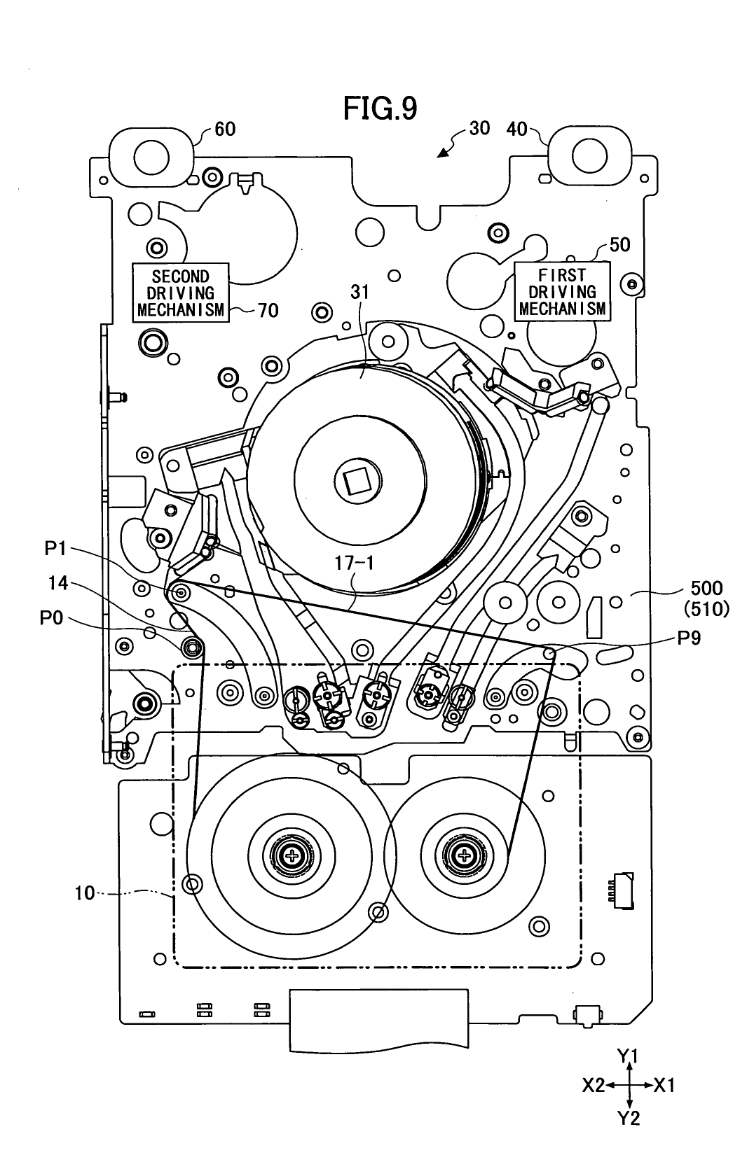

First, the pole P1, P9 movement operation 121 is performed. As shown in FIG. 9, the common action motor 40 is rotated clockwise, the first driving mechanism 50 is operated, the pole P1 is moved generally in the X2 direction, the pole P9 is moved generally in the X2 direction, and the magnetic tape 14 is drawn out from the tape cassette to form a first tape path 17-1.

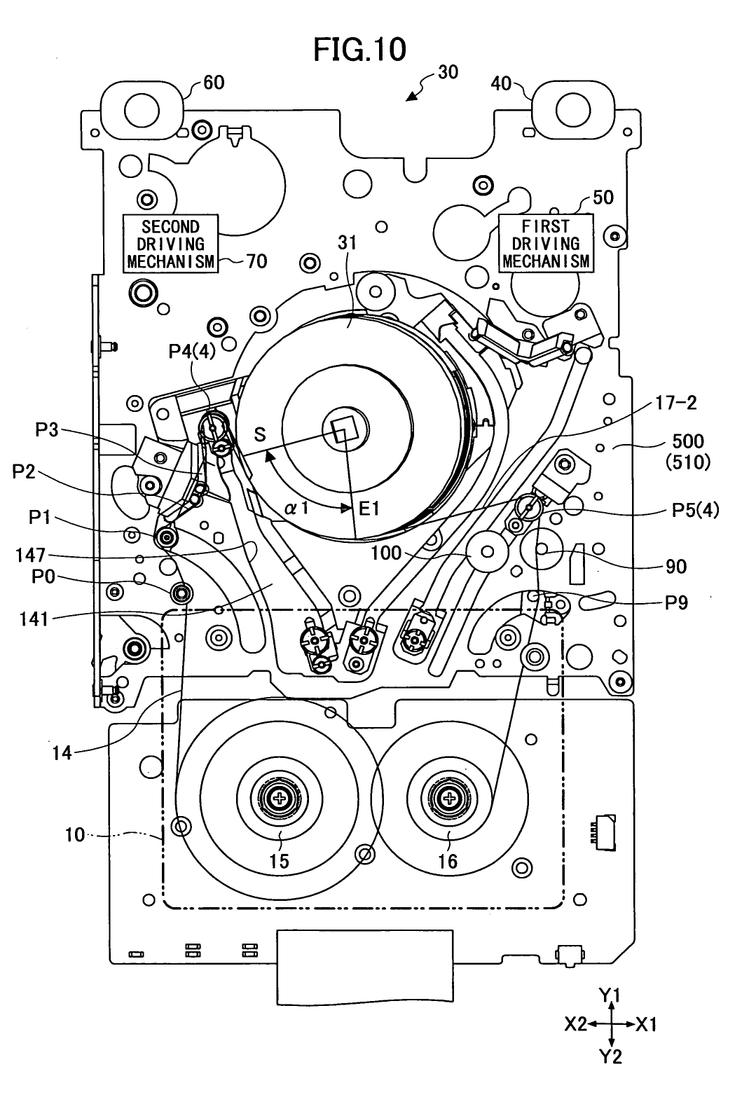

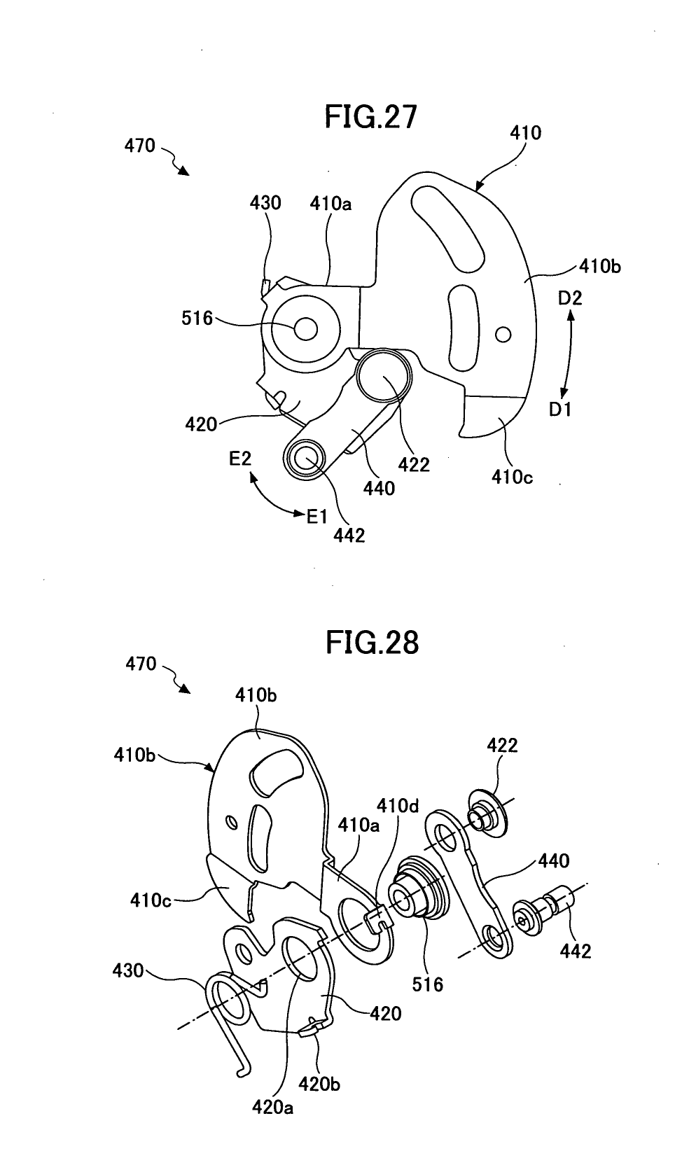

Next, the pole P4(4), P5(4) movement operation 122 is performed. As shown in FIG. 10, the individual action motor 60 is rotated clockwise and the second driving mechanism 70 is operated. The pole P4(4) is fitted to the guide rail part 147 on the X2 side of the passage 141 and engaged with the guide rail part 147 (see FIG. 27). The pole P4(4) is moved generally in the Y1 direction along the passage 141 to the location where the pole P4(4) contacts the stopper 151. The pole P5(4) is moved generally in the Y1 direction along the passage 144 to the location where the pole P5(4) contacts the stopper 154.

The poles P4(4) and P5(4) further draw out the magnetic tape 14 and expand the tape path 17-1 further. As a result, the magnetic tape 14 is arranged slantingly on the rotary drum device 31 and has the drum contact angle α1 (about 90 degrees) on the rotary drum device 31 from location S to location E1 so that a final tape path 17-2 in contact with the capstan 90 is formed. At this time, the pole P5(4) and the magnetic tape 14 pass by the Z2 side of the pinch roller 100 without interfering with the pinch roller 100.

The magnetic tape 14 comes out from the tape-supply reel 15 side of the current tape cassette 10, and it is guided by the poles P0 and P1 and twisted by the poles P2 and P3. The portion of the magnetic tape 14 between the pole P4(4) and the pole P5(4) is wound around the rotary drum device 31, and it is guided by the capstan 90 and the pole P9 so that it enters the take-up-reel 16 side of the current tape cassette 10. In this manner, the final tape path 17-2 is formed by the magnetic tape 14.

Next, the pinch roller movement operation 123 is performed. As shown in FIG. 11, the common action motor 40 is rotated clockwise, the first driving mechanism 50 is operated, and the pinch roller 100 is first lowered in the Z2 direction and then enters the tape path 17-2. Subsequently, the pinch roller 100 is moved in the X1 direction and engages the capstan 90 by pressure, so that the magnetic tape 14 starts running in the direction indicated by the arrow 139 and the streamer device 30 starts performing recording or reproducing of information in the magnetic tape 14.

The end location where the magnetic tape 14 is wound on the rotary drum device 31 is indicated by E1, and the magnetic tape 14 is separated from the rim of the rotary drum device 31 immediately before the rotary head which scans the magnetic tape 14 slantingly reaches the uppermost edge of the magnetic tape 14. Therefore, it is possible to prevent the rotary head from crossing the uppermost edge of the magnetic tape 14, and to prevent damage to the magnetic tape resulting from the rotary head crossing the uppermost edge of the magnetic tape 14.

Next, the head cleaner movement operation 124 is performed. Similarly, as shown in FIG. 11, the common action motor 40 is rotated clockwise, the first driving mechanism 50 is operated, and the head cleaner 110 is moved as indicated by the two-dot chain line in FIG. 11 to contact the rotary drum device 31 and clean the rotary head.

The tape unloading action is performed by the above-mentioned operations in the sequence opposite to the above-mentioned sequence and by moving the above-mentioned elements in the direction opposite to the above-mentioned direction.

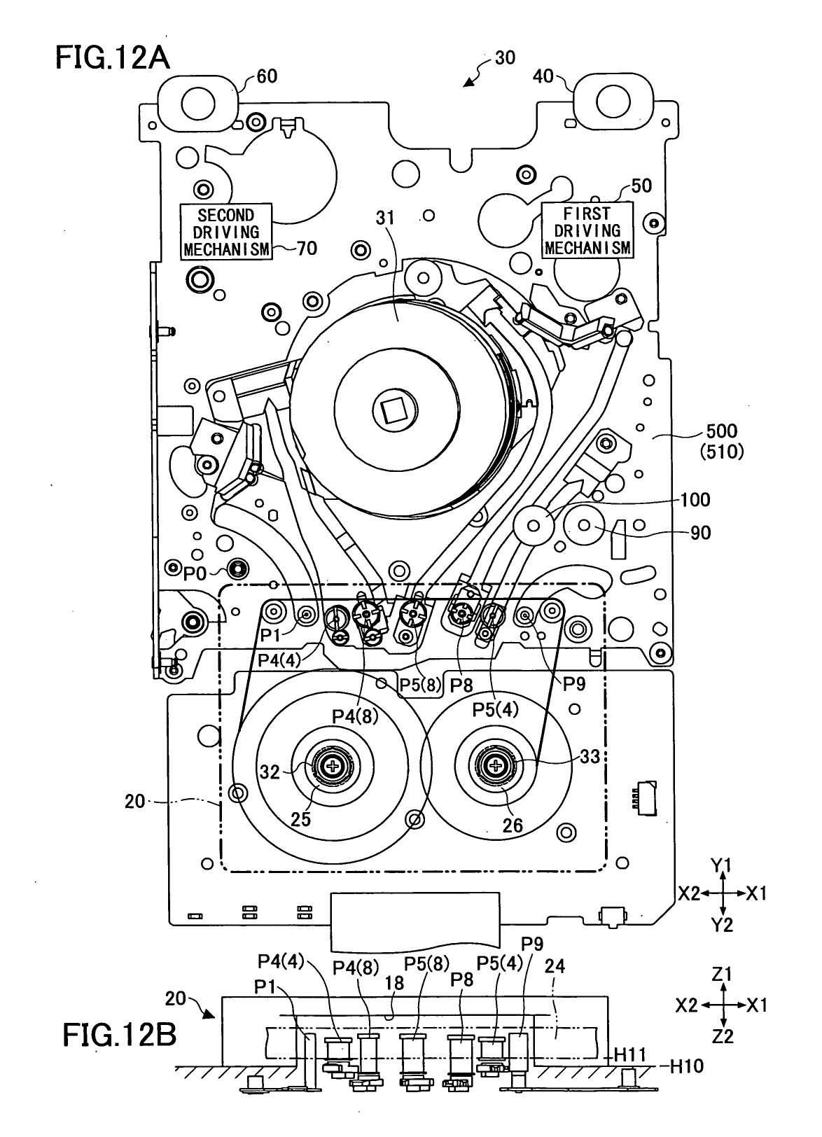

Next, a description will be given of the tape loading action when a new tape cassette 20 is attached with reference to FIG. 12A through FIG. 18.

FIG. 12A and FIG. 12B show the condition of the streamer device in which a new tape cassette 20 is attached. The new tape cassette 20 is attached with the bottom base being set at the height H10. The sliding plate (not shown) is moved and the tape-supply reel 25 and the take-up reel 26 are fitted to the tape-supply reel shaft device 32 and the tape-winding shaft device 33, respectively. The lid 22 is opened and the poles P1, P4(4), P4(8), P5(8), P8, P5(4), and P9 enter the pole accommodating space 28. The recess 29 in the cassette body 23 faces the tape cassette distinction switch 32, and the tape cassette distinction switch 32 is not pressed by the cassette body 23, so that the new tape cassette detection operation 130 is performed. The height of the lowermost edge of the magnetic tape 24 is the same as the height H11 of the lowermost edge of the magnetic tape 14 of the current tape cassette 10 when it is attached.

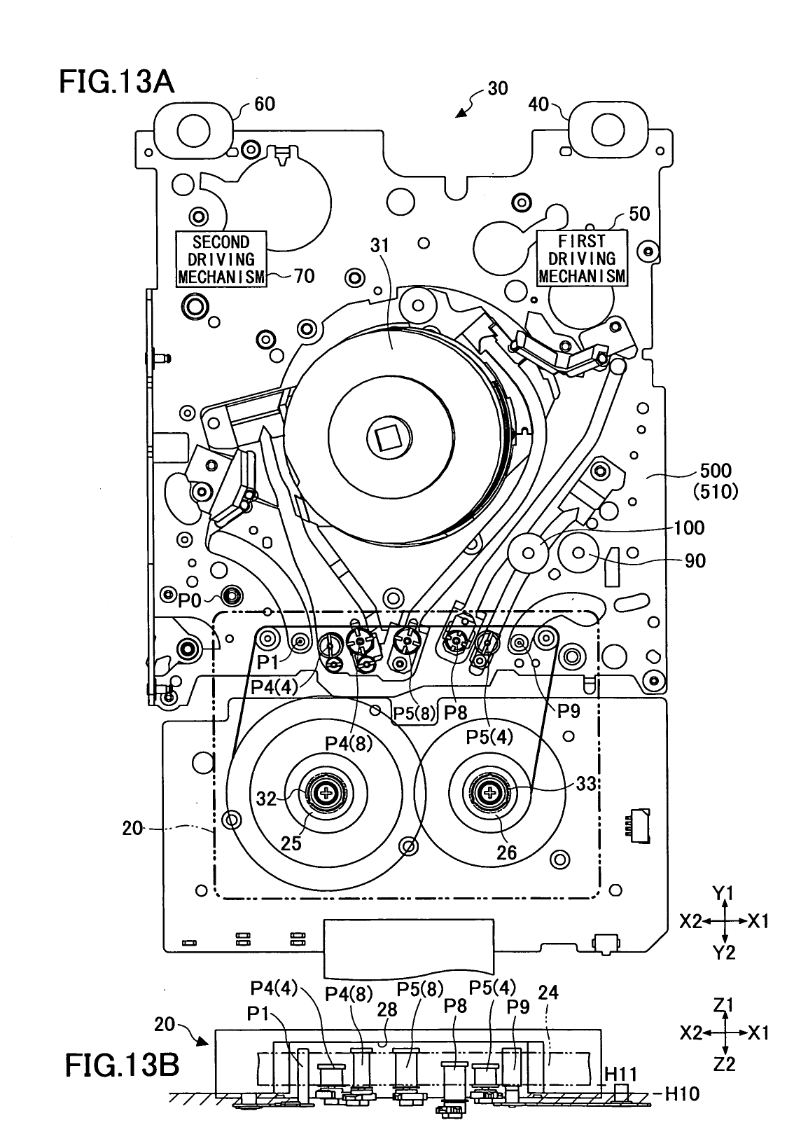

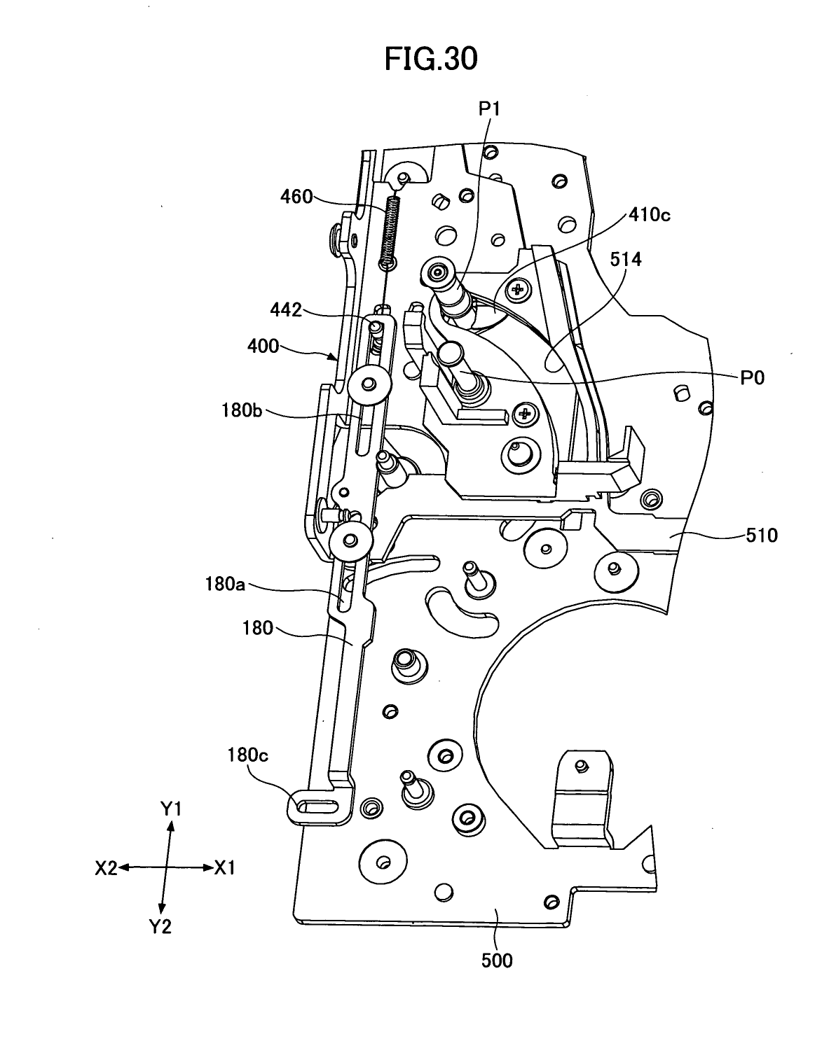

First, the pole P1, P5(8), P8, and P9 movement operation 131 is performed. As shown in FIG. 13A and FIG. 13B, the individual action motor 60 is rotated counterclockwise, the second driving mechanism 70 is operated, and the pole lifting/lowering mechanism 280 (see FIG. 30) is operated. The poles P1, P5(8), P8, and P9 are lifted in the Z1 direction in the pole accommodating space 28, and they are in the position in which they face the whole width of the 8 mm wide magnetic tape 24.

If the poles which do not fully face the whole width of the 8 mm wide magnetic tape 24 are moved to draw out the magnetic tape, the hooking becomes imperfect which causes damage to the magnetic tape. However, if the poles fully face the 8 mm wide magnetic tape 24 as mentioned above, it is possible to hook and draw out the magnetic tape 24 without damaging the magnetic tape 24.

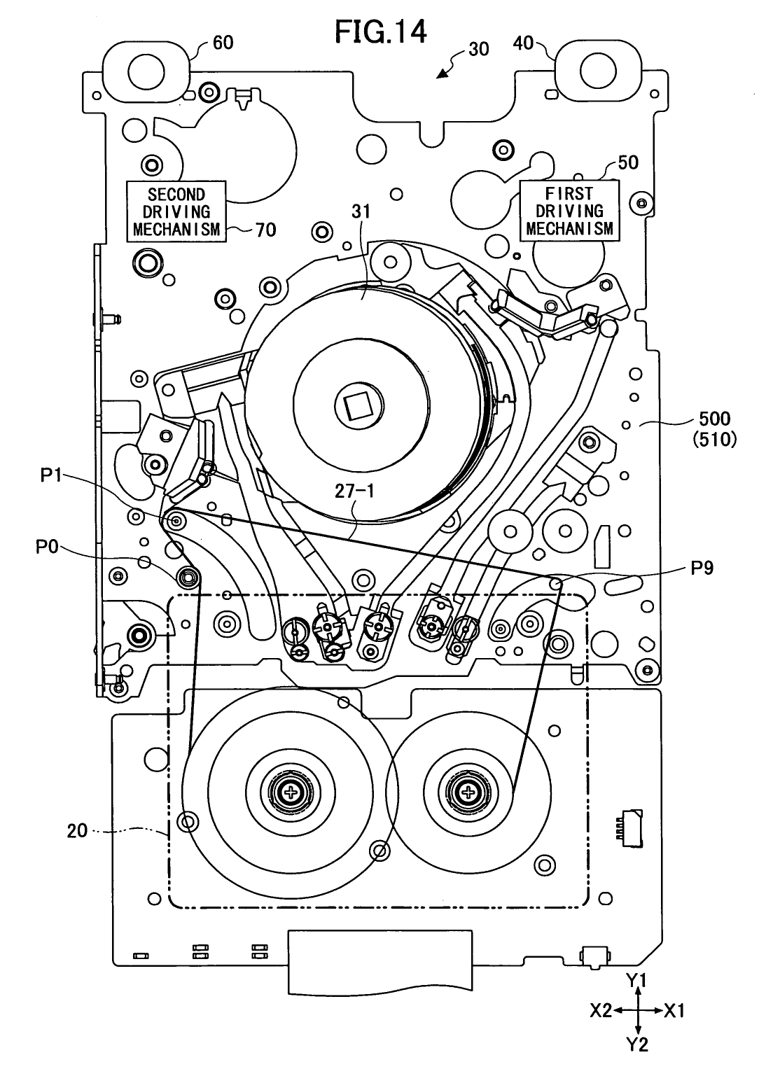

Next, the pole P1 and P9 movement operation 132 is performed. As shown in FIG. 14, the common action motor 40 is rotated clockwise, the first driving mechanism 50 is operated, the pole P1 is moved generally in the X2 direction, the pole P9 is moved generally in the X2 direction, and the magnetic tape 24 is drawn out from the tape cassette to form the first tape path 27-1.

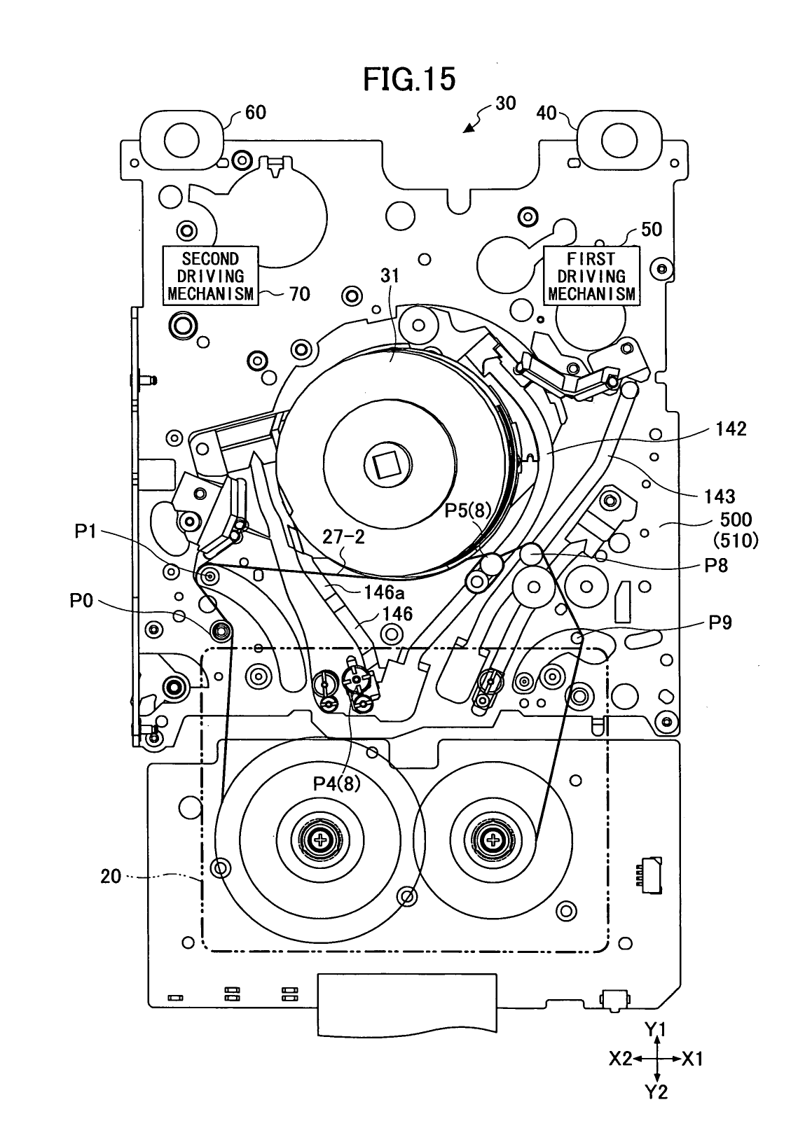

Next, the pole P5(8), P8, P4(8) movement operation 133 is performed. As shown in FIG. 15, the individual action motor 60 is rotated counterclockwise, and the second driving mechanism 70 is operated. The pole P5(8) is moved generally in the Y1 direction along the passage 142, and the pole P8 is moved generally in the Y1 direction along the passage 143, so that the magnetic tape 24 is drawn out further. The tape path 27-1 turns into the tape path 27-2 in which the magnetic tape 14 contacts the rotary drum device 31.

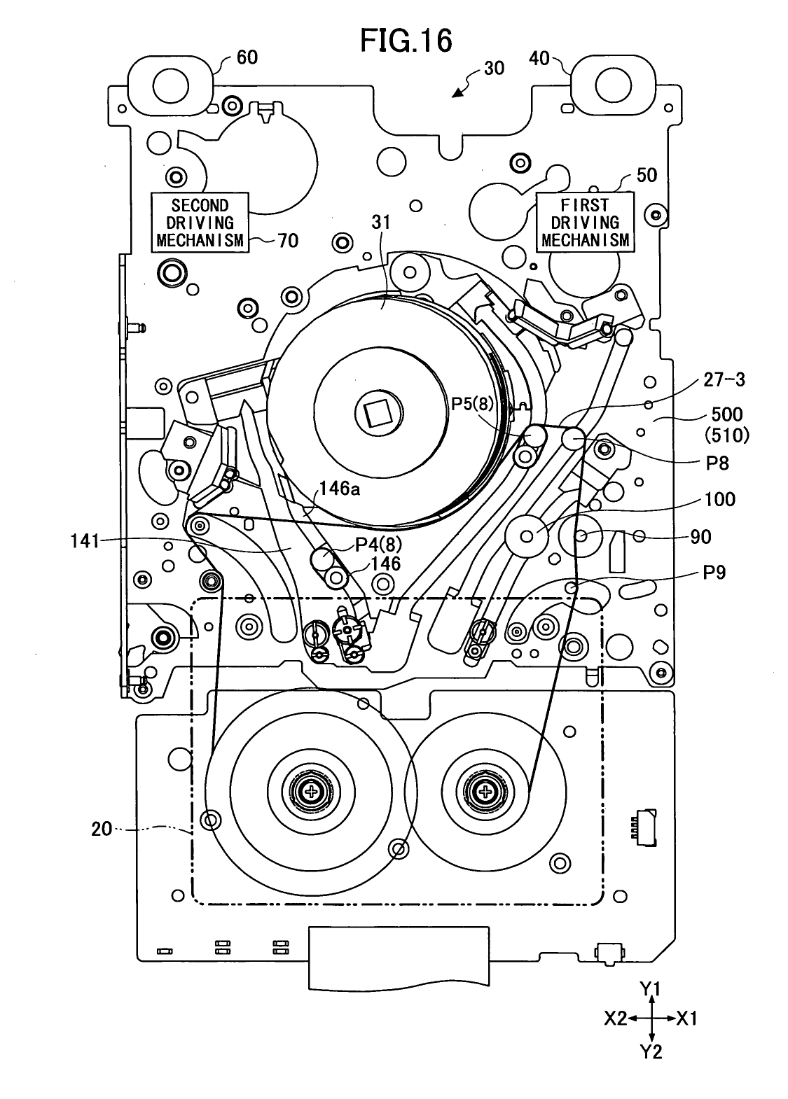

Subsequently, as shown in FIG. 16, the pole P4(8) is moved generally in the Y1 direction. The pole P4(8) is fitted to the guide rail part 146 on the X1 side of the passage 141 and engaged with the guide rail part 146. The guide rail part 146 includes a slope part 146a having a slope in the Z1 direction at the intermediate part. The pole P4(8) is lifted in the Z1 direction in the progress of movement, and placed at the height which faces the magnetic tape 24. During the subsequent movement, the pole P4(8) hooks the magnetic tape 24.

A first reason the time of moving the pole P4(8) is delayed is that, because of the miniaturization of the streamer device 30, a passage for exclusive use with the pole P4(8) is not provided, and the passage 141 of the pole P4(4) is used. A second reason for this delay is that the pole P4(8) is lifted in the progress of its movement. A third reason for this delay is that the location of the magnetic tape 24 is arranged at a relatively large distance from the new tape cassette 20 in the Y1 direction, in order to finish the lifting before the pole P4(8) arrives at the location of the magnetic tape 24.

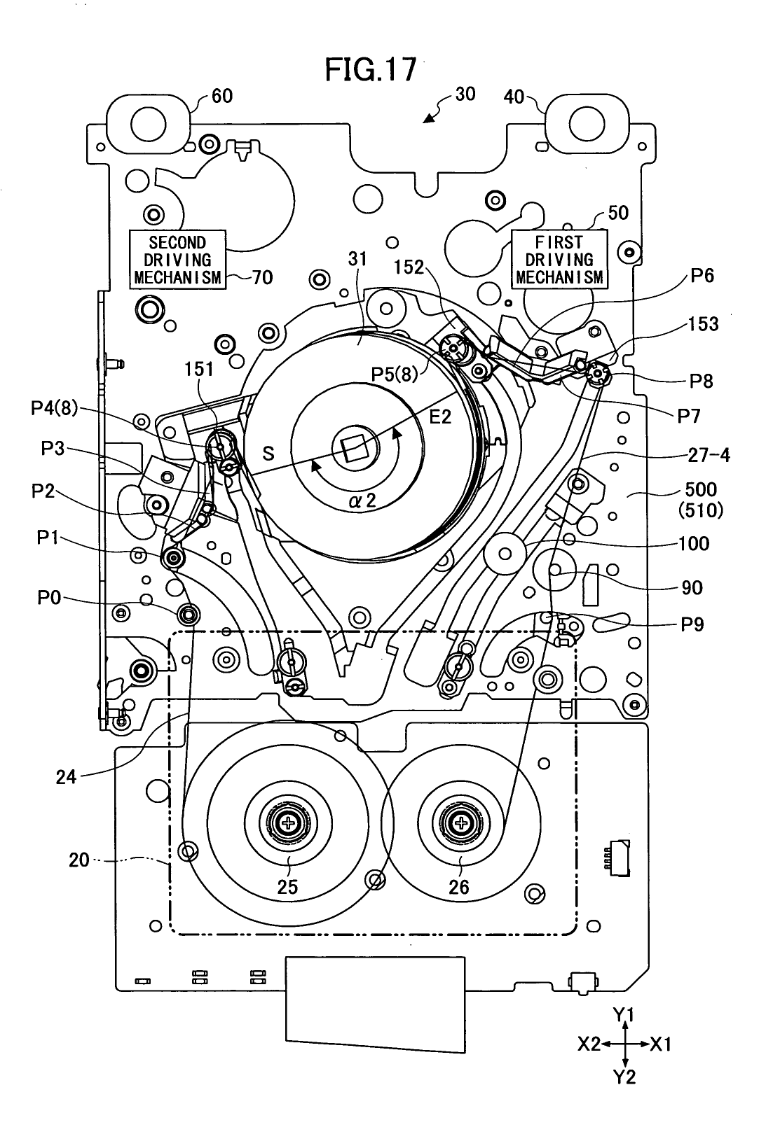

As shown in FIG. 17, the pole P4(8), the pole P5(8) and the pole P8 reach and contact the stopper 151, the stopper 152 and the stopper 153, respectively, at the same time, and the tape path 27-2 is further expanded through the tape path 27-3 of FIG. 16. The magnetic tape 24 is arranged slantingly on the rotary drum device 31 and has the drum contact angle α2 (about 180 degrees) on the rotary drum device 31 from location S to location E2, so that a final tape path 27-4 in contact with the capstan 90 is formed. At this time, the pole P8 and the magnetic tape 24 pass by the Z2 side of the pinch roller 100 without interfering with the pinch roller 100.

The magnetic tape 24 comes out from the tape-supply reel 25 side of the new tape cassette 20, and it is guided by the poles P0 and P1 and twisted by the poles P2 and P3. The portion of the magnetic tape 24 between the pole P4(4) and the pole P5(8) is wound around the rotary drum device 31 and guided and twisted by the poles P6 and P7, and then it is guided by the pole P8, the capstan 90 and the pole P9, so that it enters the take-up-reel 26 side of the new tape cassette 20. In this manner, the final tape path 27-4 is formed by the magnetic tape 24.

Next, the pinch roller movement operation 134 is performed. As shown in FIG. 18, the common action motor 40 is rotated clockwise, the first driving mechanism 50 is operated, and the pinch roller 100 is first lowered in the Z2 direction and then enters the tape path 27-4. Subsequently, the pinch roller 100 is moved in the X1 direction and engaged to the capstan 90 by pressure, so that the magnetic tape 24 starts running in the direction indicated by the arrow 139 and the stream device 30 starts performing recording or reproducing of information in the magnetic tape 24.

The end location where the magnetic tape 24 is wound on the rotary drum device 31 is indicated by E2, and the magnetic tape 24 is separated from the rim of the rotary drum device 31 immediately before the rotary head which scans the magnetic tape 24 slantingly reaches the uppermost edge of the magnetic tape 24. Therefore, it is possible to prevent the rotary head from crossing the uppermost edge of the magnetic tape 24, and to prevent damage to the magnetic tape resulting from the rotary head crossing the uppermost edge of the magnetic tape 24.

Next, the head cleaner movement operation 135 is performed. Similarly, as shown in FIG. 18, the common action motor 40 is rotated clockwise, the first driving mechanism 50 is operated, and the head cleaner 110 is moved as indicated by the two-dot chain line in FIG. 18 to contact the rotary drum device 31 and clean the rotary head.

The tape unloading action is performed by the above-mentioned operations in the sequence opposite to the above-mentioned sequence of the tape loading action and by moving the above-mentioned elements in the direction opposite to the above-mentioned direction of the tape loading action.

Because the fixed poles P2 and P3 are used to twist the magnetic tape 14 (24) at the location in the running direction preceding the location where the magnetic tape 14 (24) reaches the rotary drum device 31, only the movable poles P4(4) and P4(8) are moved to draw out the magnetic tape 14 (24), arrange the magnetic tape 14 (24) around the rim of the rotary drum device 31, and determine the outlet end location of the magnetic tape 14 (24) from the rotary drum device 31. Because the fixed poles P6 and P7 are used to twist the magnetic tape 24 at the location in the running direction following the location where the magnetic tape 24 comes out from the rotary drum device 31, only the movable pole P5(8) is moved to draw out the magnetic tape 24 and determine the outlet end location of the magnetic tape 24 from the rotary drum device 31. Accordingly, all the movable poles can be arranged within the area of the pole accommodating space 18 (28).

Next, a description will be given of the common action motor 40, the first driving mechanism 50, and the mechanism operated by the power from the first driving mechanism 50.

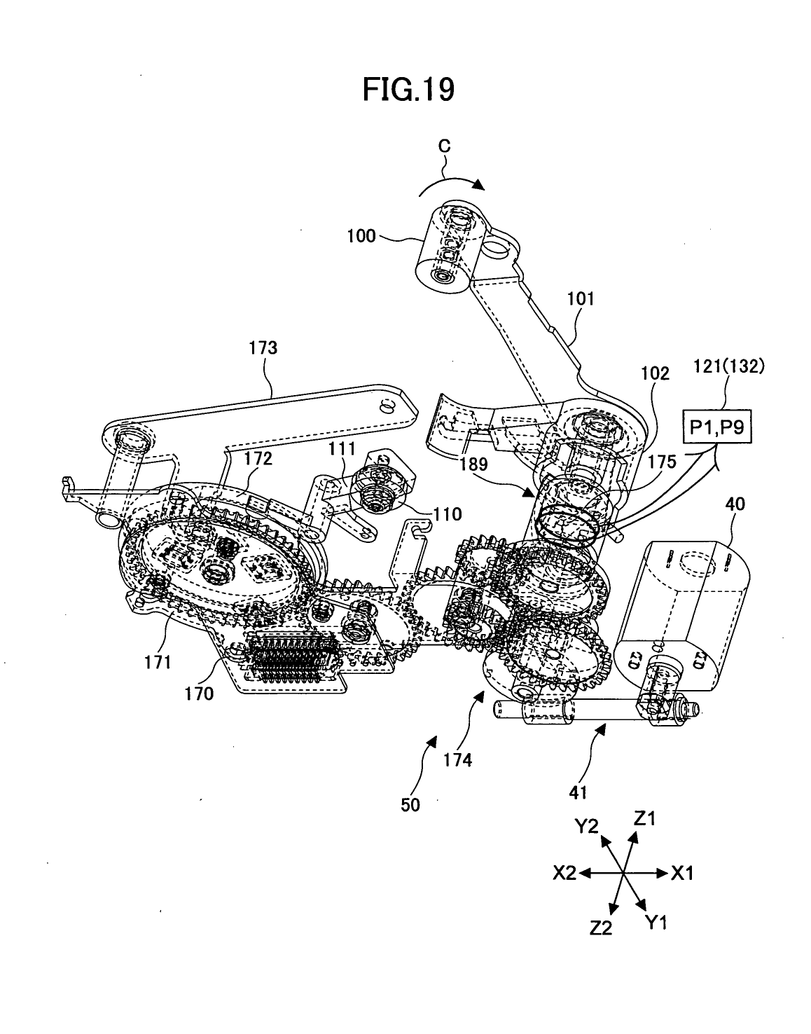

FIG. 19 shows the bottom side of the first driving mechanism 50 when the streamer device 30 is in the condition shown in FIG. 1. In FIG. 19, reference numeral 170 denotes an operating state detection circuit board, and two or more photo-reflectors are provided in this operating state detection circuit board. Reference numeral 171 denotes a common mode switch gear, and a mode switch pattern is formed on the bottom surface of this switch gear. Reference numeral 172 denotes a cam part which is arranged on the top surface of the common mode switch gear 171. Reference numeral 173 denotes a tape cassette mounting arm which is rotated by the cam part 172, so that the tape cassette mounting mechanism (not shown) is operated.

The operating state detection circuit board 170 optically detects a rotation angle position of the common mode switch gear 171 based on the combination of the outputs from the photo-reflectors, and therefore detects the operating state of the first driving mechanism 50. As shown in FIG. 2, a detection signal from the operating state detection circuit board 170 is sent to the control circuit 82. The motor driver 80 is operated in accordance with a control signal from the control circuit 82. The rotation of the common action motor 40 is started or stopped at a predetermined timing. Thereby, the pole P1, P9 movement operation 121, the pinch roller movement operation 123, the head cleaner movement operation 124, as shown in FIG. 3, and the pole P1, P9 movement operation 131, the pinch roller movement operation 134, and the head cleaner movement operation 135, as shown in FIG. 4, are performed.

Because the common mode switch gear 171 functions as a mode switch by itself, the mode location detection can be performed with high accuracy in the above-described embodiment when compared with the composition in which the function of the mode switch is provided in another part other than in the gear 171.

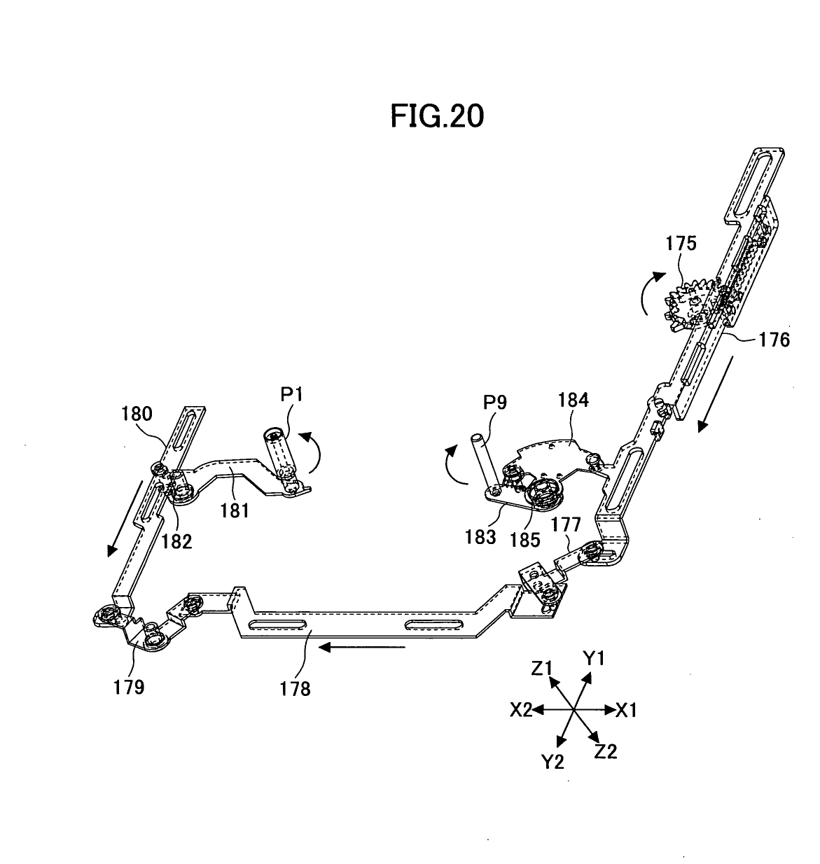

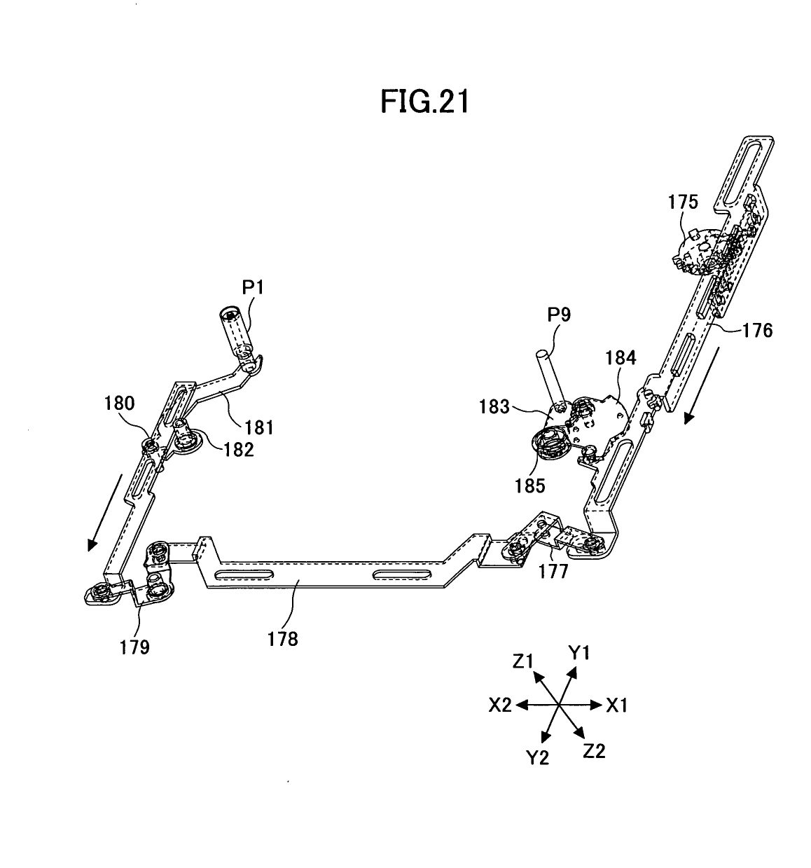

Next, a description will be given of the pole P1, P9 movement operation 121 (131) (see FIG. 20 and FIG. 21). The pole P1 is fixed at the head-end part of an arm 181. The pole P9 is fixed at the head-end part of an arm 183. A sleeve 182 is fixed to the base of the arm 181, and this sleeve 182 is fitted to a fixed post which is embedded in the chassis base. The sleeve 182 is rotatably and slidably supported on the fixed post. A sleeve 185 is fixed to the base of the arm 183, and this sleeve 185 is fitted to a fixed post which is embedded in the chassis base. The sleeve 185 is rotatably and slidably supported on the fixed post.

When the common action motor 40 is driven, a gear mechanism 174 is driven via a worm-gearing device 41, and a drive gear 175 is rotated clockwise in FIG. 20. As shown in FIG. 21, a slide lever 176 is moved in the Y2 direction, and a slide lever 180 (which is equivalent to a driving force transmitting member in the claims) is moved in the Y2 direction via a rotation lever 177, a link 178, and a rotation lever 179.

By the sliding movement of the slide lever 180, the arm 181 (which is equivalent to an arm member in the claims) is rotated counterclockwise around the fixed post (on which the sleeve 182 is supported), and thereby the pole P1 (which is equivalent to a tape guide member in the claims) is moved. By the sliding movement of the slide lever 176, the arm 184, 183 is rotated clockwise around the fixed post (on which the sleeve 185 is supported), and thereby the pole P9 is moved.

Next, a description will be given of the pinch roller movement operation 123 (134) (see FIG. 19). When the common action motor 40 is driven, a cylinder portion 102 on the base of a pinch roller support arm 101 is lowered in the Z2 direction by a spiral cam mechanism 189 while the cylinder portion 102 is guided by the vertical slot. Subsequently, when the end of the vertical slot is reached, the head-end part of the pinch roller support arm 101 is rotated in the C direction. Thereby, the pinch roller 100 is engaged to the capstan 90 by pressure caused by the spring force.

Next, a description will be given of the head cleaner movement operation 124 (135) (see FIG. 19). When the common action motor 40 is driven, the common mode switch gear 171 is rotated, and the arm member 111 is rotated by the cam part 172 formed integrally with the common mode switch gear 171, so that the head cleaner 110 is moved to contact the rotary drum device 31.

When the common mode switch gear 171 is rotated in the direction reverse to the above-mentioned direction after it is rotated until the head cleaner 110 is moved, the above-mentioned actions are performed in order of the action 124 (135), the action 123 (134), and the action 121 (131), and the respective elements are moved in the direction reverse to the above-mentioned direction, so that they are returned to the initial state.

A description of the individual action mechanism and the individual action by the individual action motor 60 and the second driving mechanism 70 will be omitted.

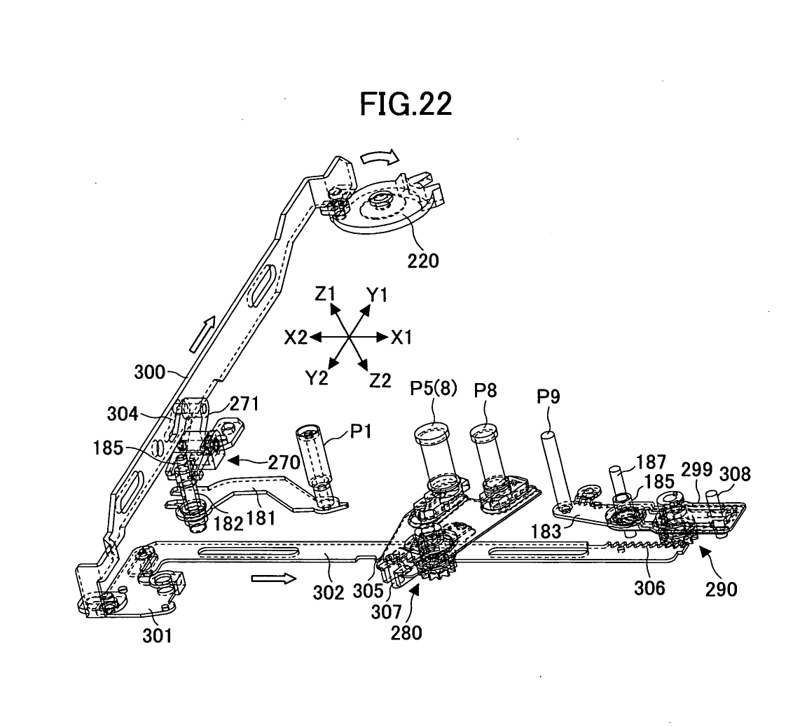

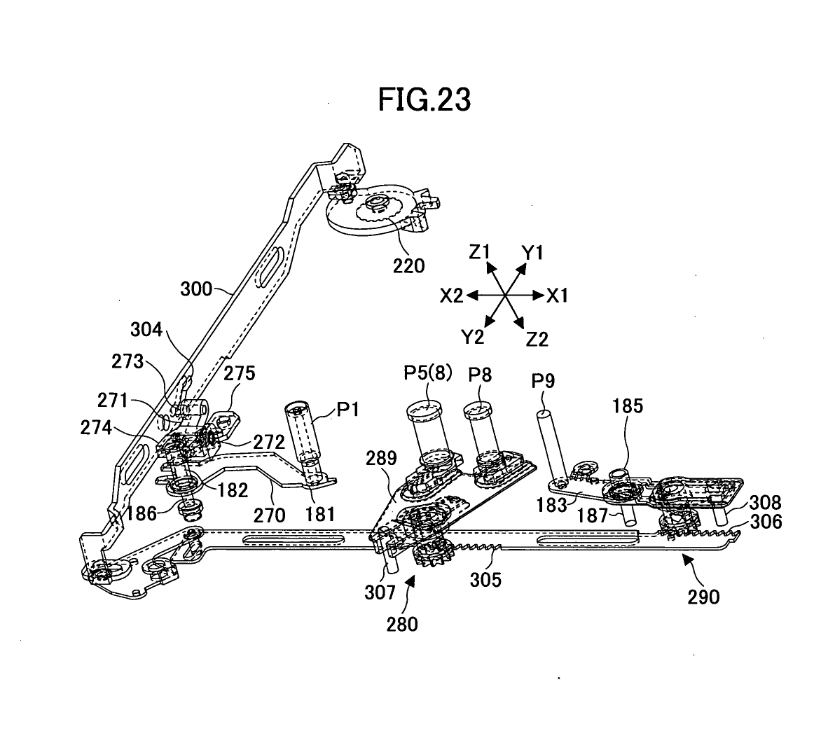

Next, a description will be given of the pole P1, P5(8), P8, P9 movement operation 131 which is performed when the new tape cassette 20 is attached, with reference to FIGS. 22 and 23.

FIG. 22 shows the condition of the pole moving mechanism in which the poles P1, P5(8), P8, and P9 are lowered in the initial state. FIG. 23 shows the condition of the pole moving mechanism in which the poles P1, P5(8), P8, and P9 are lifted.

When the second drive gear 220 is rotated clockwise by the individual mode switch gear 200, the slide lever 300 is slid in the Y1 direction and the slide lever 302 is slid in the X1 direction via the rotation lever 301. The slide lever 300 includes a cam groove 304, and the slide lever 302 includes racks 305, 306.

A pole lifting/lowering mechanism 270 of the seesaw type is arranged with respect to the pole P1. A pole lifting/lowering mechanism 280 of the spiral cam type is arranged with respect to the poles P5(8) and P8. A pole lifting/lowering mechanism 290 of the spiral cam type is arranged with respect to the pole P9.

In the pole lifting/lowering mechanism 270, the lever 271 is supported so that the shaft 272 in the center of the lever 271 moves by rocking the bracket 275. The pin 273 at the end of the lever 271 in the Y1 direction is fitted to the cam groove 304 of the slide lever 300, and the fork part 274 at the end of the lever 271 in the Y2 direction is connected the sleeve 182.

When the slide lever 300 is moved in the Y1 direction, the lever 271 is rotated by the cam groove 300a, as shown in FIG. 23, in the direction in which the fork part 274 is lifted, and the sleeve 182 is moved in the Z1 direction along with the fixed post 186, so that the pole P1 is lifted.

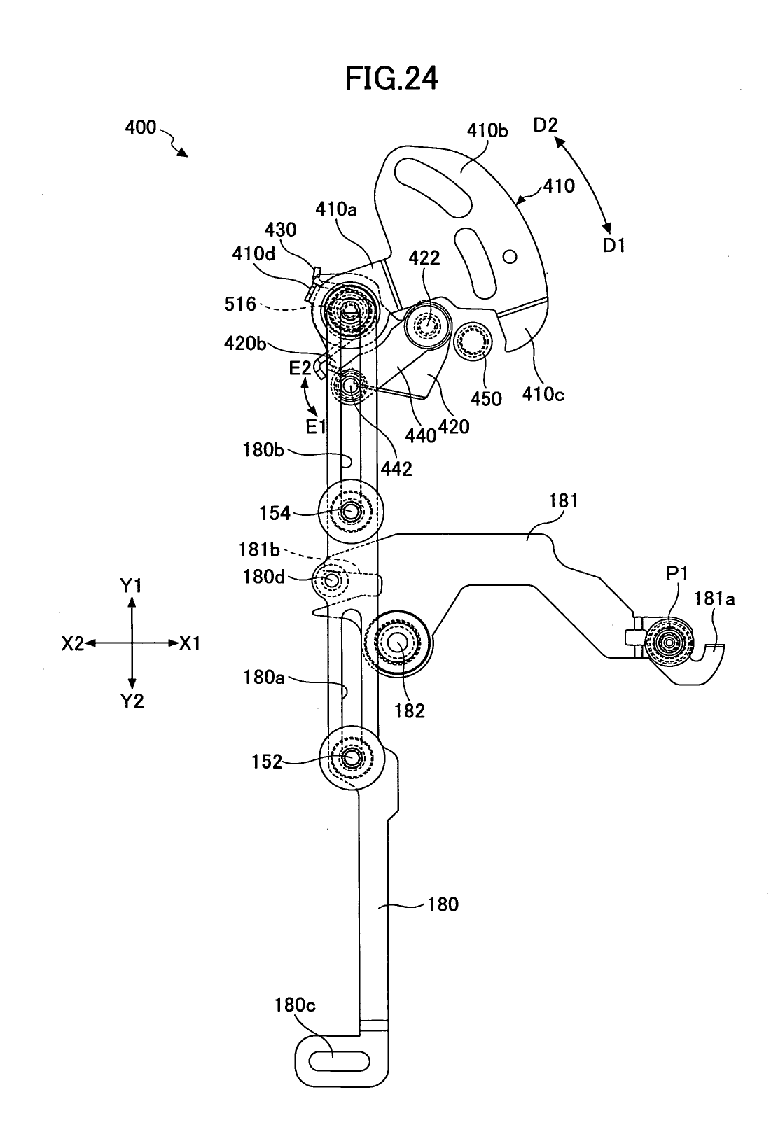

Although the pole lifting/lowering mechanisms 280 and 290 are illustrated in FIGS. 22 and 23, a description thereof will be omitted. Although a part of the tape guide moving mechanism 400 is illustrated in FIGS. 22 and 23, the structure of the tape guide moving mechanism 400 will be explained later with reference to FIG. 24 or subsequent figures.

Next, a description will be given of the tape guide moving mechanism 400 which constitutes the principal part of the invention with reference to FIGS. 24 to 37.

The tape guide moving mechanism 400 is a mechanism for drawing out the magnetic tape 14 or 24 from the pole accommodating space 18 or 28 formed inside the tape cassette 10 or 20 by moving the above-described pole P1 (tape guide member), to form the first tape path 17-1 (see FIG. 9 and FIG. 14).

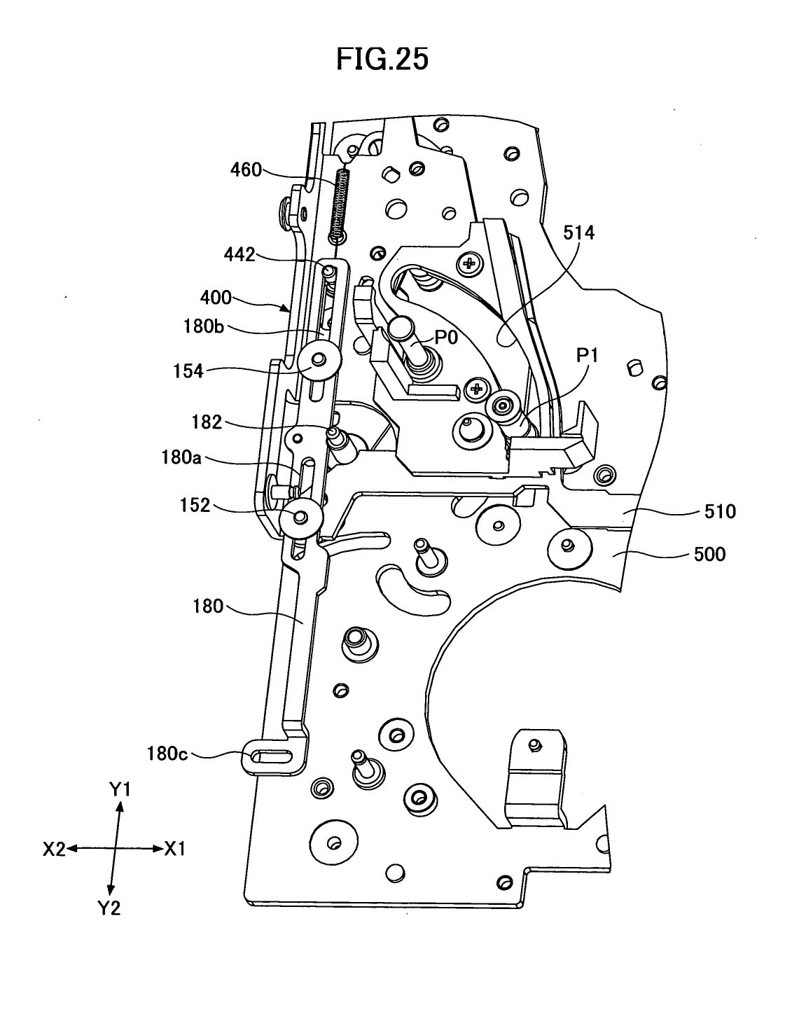

FIG. 24 is a top view showing the condition of the tape guide moving mechanism 400 before the tape loading action is performed. FIG. 25 is a perspective view showing the condition of the tape guide moving mechanism 400 before the tape loading action is performed.

As shown in FIG. 25, the respective elements of the tape guide moving mechanism 400 are arranged separately on the top surface and the bottom surface of the sub-chassis 510. However, in FIG. 24, the illustration of the sub-chassis 510 is omitted for the sake of convenience.

As shown in FIG. 24, the tape guide moving mechanism 400 includes the slide lever 180 (see FIG. 20 and FIG. 21) which actuates the pole P1, the arm 181 (see FIG. 20 and FIG. 21) which supports the pole P1, and a guide-roller hook 410 (which is equivalent to a hooking member in the claims) which hooks the pole P1 at a tape path formation position (see FIG. 9 and FIG. 14).

Moreover, the tape guide moving mechanism 400 includes: a first link 420 which is arranged coaxially with the guide-roller hook 410, a torsion spring (pressing member) 430 which generates a spring force by the relative displacement between the guide-roller hook 410 and the first link 420; a second link 440 which connects the first link 410 with the slide lever 180; and a positioning member 450 to which the projection 181a projecting from the head-end part of the arm 181 is fitted to hook the positioning member 450. The guide-roller hook 410, the first link 420, the torsion spring 430, and the second link 440 constitute a guide-roller hook unit 470.

The fixed pins 512, 514 which are fixed to the sub-chassis 510 are inserted in the slots 180a and 180b of the slide lever 180 extending in the Y1, Y2 direction. The slide lever 180 is arranged to be slidable in the Y1 or Y2 direction. The slide lever 180 includes a connecting hole 180c at the end thereof in the Y1 direction, and this connecting hole 180 is connected to the rotation lever 179. Moreover, the slide lever 180 includes an engaging pin 180d in the middle thereof in the longitudinal direction to which a groove 181b of the arm 181 is engaged, and this engaging pin 180d projects downward from the bottom surface of the slide lever 180.

The arm 181 includes a hooking portion 181a at the leading end of the arm 181, and this hooking portion 181a is arranged so that it is fitted to hook the positioning member 450. The arm 181 is rotatably supported on the fixed post 182 on the bottom surface of the sub-chassis 510. The pole P1 is supported at the head-end part (one end) of the arm 181, and the groove 181b is arranged at the base-end part (the other end) of the arm 181. Therefore, when the slide lever 180 is slid in the Y1 or Y2 direction, the arm 181 is rotated around the fixed post 182.

Because no spring force acts on the arm 181 as in the conventional device, the frictional force between the groove 181b of the arm 181 and the engaging pin 180d of the slide lever 180 is reduced, and the rotating operation of the arm 181 can be performed with little friction. The lifting/lowering action of the arm 181 is performed when the tape cassette 10 or 20 is attached. The sliding resistance (friction) in such a case is also reduced, and the tape loading action can be performed smoothly.

The guide-roller hook 410 includes: a support portion 410a which is rotatably supported on a fixed shaft 516 fixed to the sub-chassis 510; a rotating portion 410b which is formed to extend in the direction separate from the fixed shaft 516; and a hooking portion 410c which projects from the side face of the rotating part 410b in the D1 direction (which is the rotating direction of the guide-roller hook 410).

The hooking portion 410c is formed in a triangular configuration so that the hooking portion 410c hooks the pole P1 immediately before the tape loading action is completed, which will be described later. The hooking portion 410c is arranged so that the hooking portion 410c is placed in the location evacuated from the circular opening 514 immediately before the tape loading action is completed and when the tape unloading action is started. Moreover, immediately after the pole P1 arrives at the end point of the tape loading action (the location where the projection 181a of the arm 181 contacts the positioning member 450), the hooking portion 410c is rotated in the D1 direction to enter the returning path of the pole P1, so that the hooking portion 410c hooks the pole P1.

The first link 420 is rotatably supported on the fixed shaft 516 at one end thereof similar to the guide-roller hook 410. The first link 420 includes a connecting pin 422 which is raised up at the other end thereof. The second link 440 is connected at one end to the connecting pin 422 rotatably. And an engaging pin 442 which is engaged with the slot 180b of the slide lever 180 is raised up at the other end of the second link 440. The second link 440 is arranged so that the second link 440 is rotatable in the E1 or E2 direction around the connecting pin 422.

When the slide lever 180 is slid in the Y2 direction at the time of the tape loading action, the engaging pin 442 is in contact with the edge wall of the slot 180b and thereby starts moving in the Y2 direction. This movement of the engaging pin 442 is transmitted to the guide-roller hook 410 via the second link 440 and the first link 420.

As shown in FIG. 25, a return spring 460 is arranged on the top surface of the sub-chassis 510 so that the return spring 460 pulls the slide lever 180 back in the Y1 direction. The pole P1 projecting from the bottom surface of the sub-chassis 510 is inserted in the circular opening 514 formed in the sub-chassis 510. The pole P1 is moved in the inside of the circular opening 514 by the rotating operation of the arm 181 arranged on the bottom surface of the sub-chassis 510.

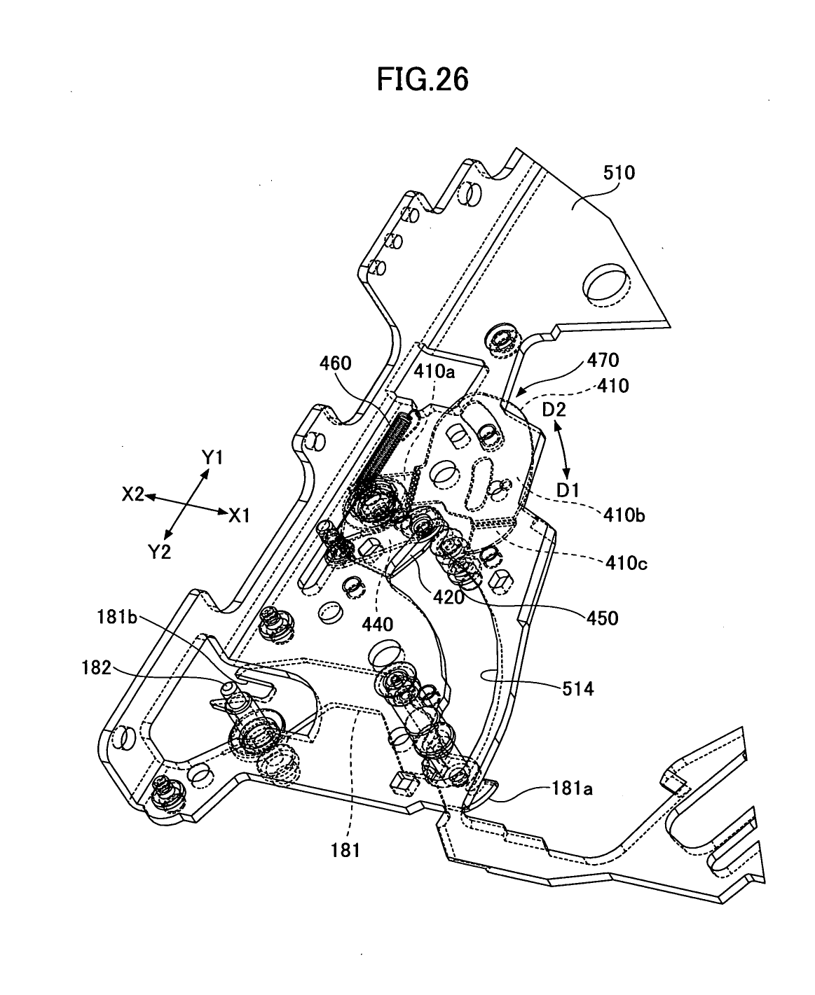

FIG. 26 is an enlarged perspective view showing the respective members of the tape guide moving mechanism 400 before the tape loading action is performed. In FIG. 26, the elements arranged on the bottom surface of the sub-chassis 510 are indicated by the dotted lines.

As shown in FIG. 26, before the tape loading action is performed, the pole P1 is in the location where the tape cassette is attached, and the guide-roller hook 410 is in the location where the hooking portion 410c is evacuated from the circular opening 514 (on the D2 direction side).

FIG. 27 is a diagram showing the assembly condition of the guide-roller hook unit 470. FIG. 28 is an exploded perspective view of the guide-roller hook unit 470. As shown in FIGS. 27 and 28, in the guide-roller hook unit 470, the guide-roller hook 410 and the first link 420 are connected to the fixed shaft 516 coaxially, and the guide-roller hook 410 and the first link 420 are retained by the spring force of a torsion spring 430, attached to the rim of the fixed shaft 516, in the direction in which they overlap mutually.

The first link 420 includes a hole 420a in which the fixed shaft 516 is inserted, and a spring hooking part 420b formed on the side face of the first link 420 arranged in the rotation direction thereof. The torsion spring 430 is fitted at one end to the spring hooking part 410d arranged on the rim of the support portion 410a of the guide-roller hook 410, and fitted at the other end to the spring hooking part 420b of the first link 420. The spring hooking part 410d and the spring hooking part 420b are located on both sides of the fixed shaft 516 at the 180 degree opposite phase positions. The spring force of the torsion spring 430 acts on the spring hooking part 410d and the spring hooking part 420b to rotate the guide-roller hook 410 and the first link 420 in their separating directions.

The engaging pin 442 is fixed to the hole of the other end of the second link 440 by crimping. The connecting pin 422 is inserted in the hole of the second link 440 at one end thereof and fixed to the hole of the first link 420 the other end thereof by crimping.

In the thus arranged guide-roller hook unit 470, immediately before the slide operation of the slide lever 180 is completed, the internal end part of the slot 180b is in contact with the engaging pin 442 and the slide lever 180 presses the engaging pin 442 in the Y2 direction. Thereby, the second link 440 is rotated in the E1 direction, and the guide-roller hook 410 and the first link 420 are rotated together in the D1 direction.

Moreover, when the hooking portion 410c of the guide-roller hook 410 is moved to the location where the hooking portion 410c hooks the pole P1 by the tape loading action, the engaging pin 442 is pressed in the Y2 direction, and the first link 420 is moved in the D1 direction relative to the guide-roller hook 410 so that the ends of the torsion spring 430 are rotated in their separating directions. Thereby, the torsion spring 430 is elastically deformed to increase the spring force acting on the hooking portion 410c, and the increased spring force causes the hooking portion 410c to hook the pole P1 by pressure as the pressing force.

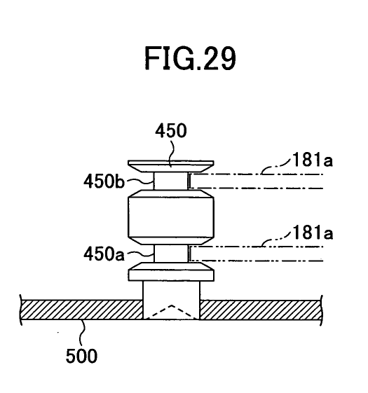

FIG. 29 is a diagram showing the mounted condition of the positioning member 450. As shown in FIG. 29, the positioning member 450 is fixed to the top surface of the main chassis 500, and the positioning member 450 includes a first groove 450a and a second groove 450b arranged on its outer periphery, and the hooking portion 181a of the arm 181 is fitted to the first and second grooves 450a and 450b. The first groove 450a and the second groove 450b serve as stoppers for positioning of the tape guide moving mechanism with respect to the rotating position of the arm 181 when the tape loading operation is completed, and with respect to the height position of the arm 181 when it is lifted or lowered in accordance with the tape cassette 10 or 20 by the pole lifting/lowering mechanism 280, respectively.

Specifically, the first groove 450a arranged in the lower location of the positioning member 450 is formed to be in conformity with the positioning height of the arm 181 (indicated by the one-dot chain line) when the current tape cassette 10 is attached, and the second groove 450b arranged in the higher location of the positioning member 450 is formed to be in conformity with the positioning height of the arm 181 (indicated by the two-dot chain line) when the new tape cassette 20 is attached.

Therefore, the hooking portion 181a of the arm 181 is fitted to the first groove 450a or the second groove 450b, and it is held in the condition that the movement of the arm 181 in the rotating direction and the height direction is regulated by the positioning member 450, and the location of the arm 181 in the rotation direction (horizontal direction) and the height position at the time of the end of the tape loading action is positioned by the positioning member 450.

Next, a description will be given of the tape loading action of the thus constituted tape guide moving mechanism 400.

As shown in FIG. 21, the driving force of the common action motor 40 is transmitted to the gear mechanism 174 via the worm-gearing device 41, and the drive gear 175 is rotated clockwise so that the tape loading action is started. Thereby, the slide lever 176 on the right-hand side of the magnetic recording/reproducing device is moved in the Y2 direction, and through the rotation lever 177, the link 178, and the rotation lever 179, the slide lever 180 of the tape guide moving mechanism 400 on the left-hand side of the device is moved in the Y2 direction.

By the sliding operation of the slide lever 180, the engaging pin 180d with which the groove 181a of the arm 181 is engaged is moved in the Y2 direction, and the arm 181 is rotated counterclockwise around the fixed post so that the pole P1 at the end of the arm 181 is moved.

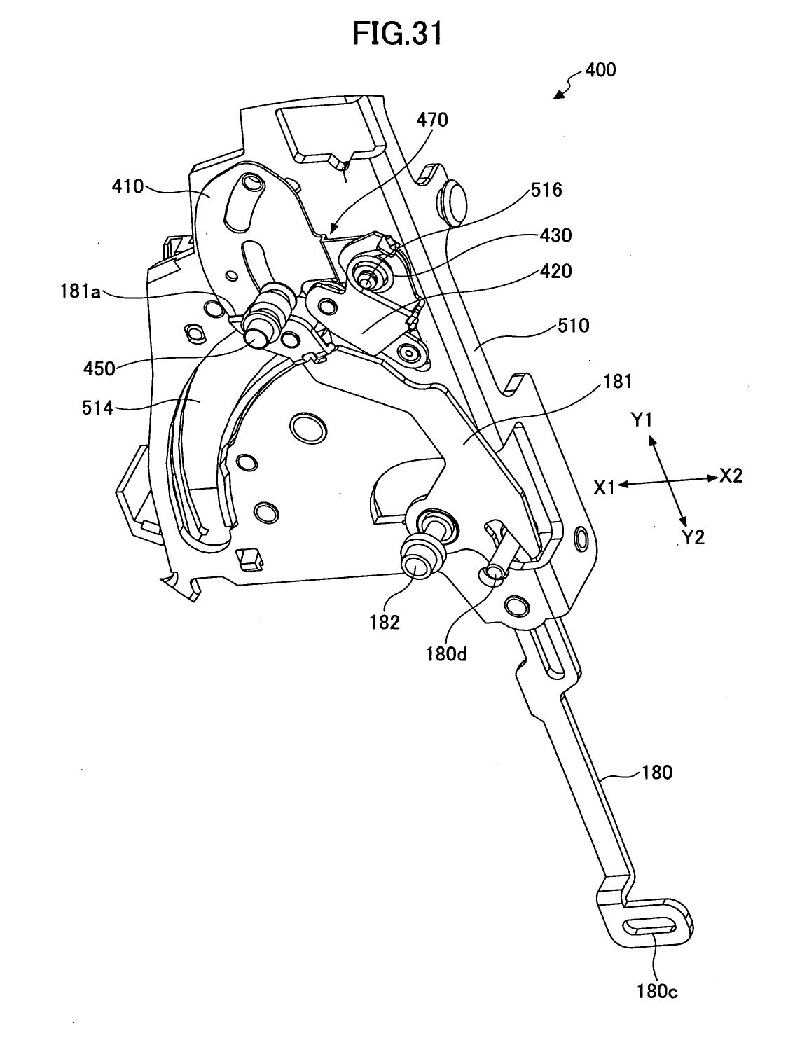

FIG. 30 is a diagram showing the top side of the tape guide moving mechanism 400 when the tape loading action is completed. FIG. 31 is a diagram showing the bottom side of the tape guide moving mechanism 400 when the tape loading action is completed. As shown in FIGS. 30 and 31, the arm 181 is rotated counterclockwise around the fixed post in accordance with the sliding operation of the slide lever 180 of the tape guide moving mechanism 400 in the Y2 direction. The pole P1 is moved in the inside of the circular opening 514 and arrives at the location in the vicinity of the end of the circular opening 514. Because the arm 181 is arranged so that it does not receive any spring force as in the conventional device, the arm 181 can be rotated smoothly.

At this time, the guide-roller hook 410 is rotated in the D1 direction, so that the hooking portion 410c enters the returning path of the pole P1 (on the clockwise rotation side) from the side and hooks the pole P1 at the tape path formation position.

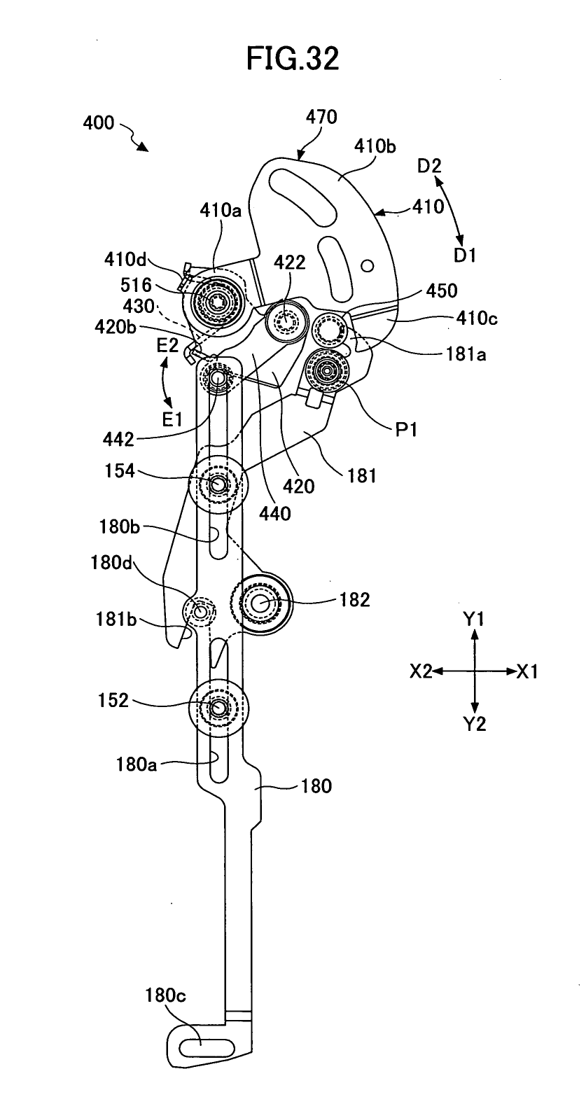

Next, a description will be given of the hooking action on the pole P1 by the tape guide moving mechanism 400 with reference to FIGS. 32 to 34.

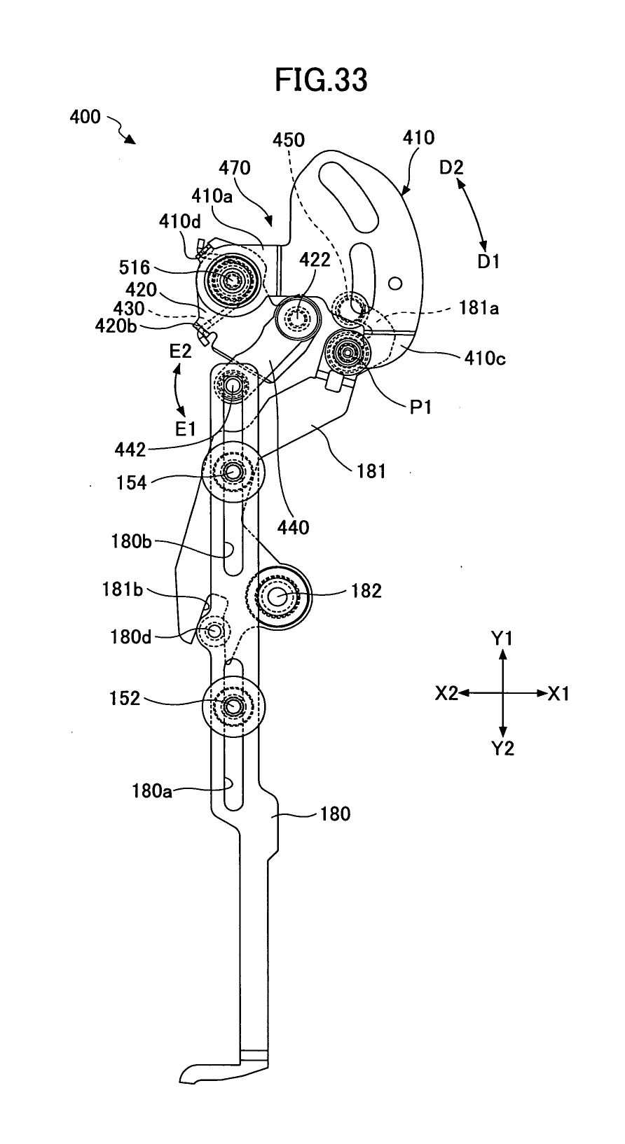

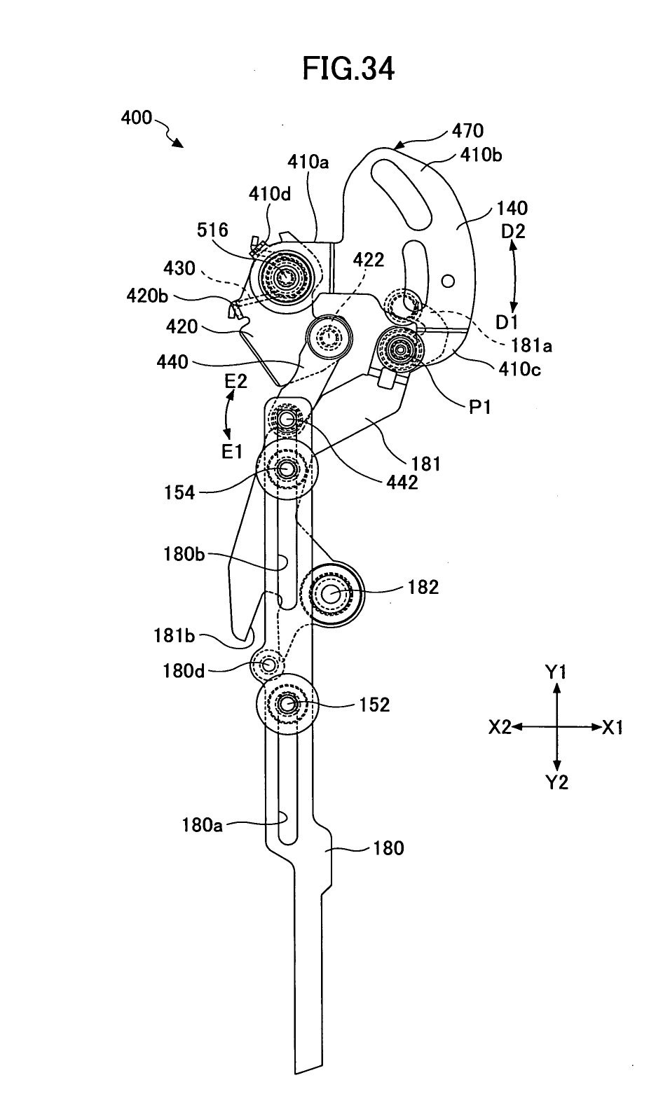

FIG. 32 is a diagram showing the condition of the tape guide moving mechanism 400 in which the arm 181 contacts the positioning member 450. FIG. 33 is a diagram showing the condition of the tape guide moving mechanism 400 in which the guide-roller hook 410 hooks the pole P1. FIG. 34 is a diagram showing the condition in which the guide-roller hook 410 is engaged to the pole P1 by pressure. In FIGS. 32 to 34, illustration of the sub-chassis 510 is omitted for the sake of convenience of description.

As shown in FIG. 32, the arm 181 is rotated counterclockwise around the fixed post 182, and the hooking portion 181a of the arm 181 is fitted to the first groove 450a or the second groove 450b of the positioning member 450. Thereby, because of the fitting of the hooking portion 181a of the arm 181 to the first groove 450a or the second groove 450b as shown in FIG. 29, the location of the arm 181 in the rotation direction (horizontal direction) and the height position at the time of the end of the tape loading action is positioned by the positioning member 450.

As shown in FIG. 33, when the slide lever 180 slides in the Y2 direction further, the edge wall of the slot 180b of the slide lever 180 contacts the engaging pin 442, thereby moving the engaging pin 442 in the Y2 direction. Because the movement of the engaging pin 442 is transmitted to the guide-roller hook 410 via the second link 440 and the first link 420, the guide-roller hook 410 is rotated in the D1 direction. Thereby, the hooking portion 410c is rotated to enter the returning path of the pole P1 (on the clockwise rotation side), and the guide-roller hook 410 contacts the pole P1. Accordingly, the pole P1 is hooked by the hooking portion 410c at the location where the tape loading action is completed, and the returning operation of the pole P1 is prevented.

As shown in FIG. 34, the slide lever 180 slides in the Y2 direction, the second link 440 which is connected to the engaging pin 442 is rotated in the E1 direction, and the second link 440 and the first link 420 are moved in the Y2 direction.

Because the rotating operation of the first link 420 serves as relative displacement to the guide-roller hook 410, a compressive load acts on the torsion spring 430. Thereby, elastic deformation of the torsion spring 430 increases the spring force, and this spring force is used as a pressing or biasing force on the guide-roller hook 410 in the D1 direction. As a result, the guide-roller hook 410 enables the pressing force by the spring force of the torsion spring 430 to act on the pole P1.

Because the spring force of the torsion spring 430 is given to the pole P1 by the hooking portion 410c while the movement of the pole P1 in the loading direction is regulated by the positioning member 450, the pole P1 is held in a stable condition without loosening. Therefore, even if the tensile force of the magnetic tape 14 or 24 which slides on the pole P1 changes, the location of the pole P1 does not change. It is possible to make the magnetic tape 14 or 24 slide on the rotary drum device 31 in a stable condition, and it is possible to increase the reliability of magnetic recording and magnetic reproducing.

The tape guide moving mechanism 400 is arranged so that the spring force of the torsion spring 430 is not used for acting on the arm 181. It is possible to reduce the sliding resistance between the engaging pin 180d and the arm 181 when the arm 181 is moved up and down, and the tape loading action can be performed smoothly.

The tape unloading action is the action which reverses the above-described tape loading action, and a description thereof will be omitted.

In the above-mentioned embodiment, the torsion spring 430 which presses the guide-roller hook 410 is looped around the fixed shaft 516 as a typical example. It is a matter of course that the above-mentioned embodiment may be arranged so that an equivalent spring member is provided in another location other than mentioned above. In addition, the above-mentioned embodiment may be arranged to use a spring force of a spring member other than the torsion spring (for example, a coil spring) for acting on the guide-roller hook 410.

It is a matter of course that the magnetic recording/reproducing device of the invention is also applicable to another device, other than the streamer device, which uses a magnetic tape.

The present invention is not limited to the above-described embodiments, and variations and modifications may be made without departing from the scope of the invention.

The present application is based upon and claims the benefit of priority of Japanese patent application No. 2007-126810, filed on May 11, 2007, the contents of which are incorporated herein by reference in their entirety.

What is claimed is:

1. A magnetic recording/reproducing device including:
a rotary drum device having a magnetic head which performs magnetic recording and magnetic reproducing of a magnetic tape;
a tape guide member drawing out a magnetic tape from a tape cassette to form a tape path in a vicinity of the magnetic head;
a tape loading member arranging the magnetic tape, drawn out from the tape cassette by the tape guide member, around a rim of the rotary drum device; and
a tape guide moving mechanism moving the tape guide member, the tape guide moving mechanism comprising:
a driving force transmitting member transmitting a driving force from a drive source;
an arm member supporting the tape guide member and being arranged so that the arm member is rotated in accordance with an action of the driving force transmitting member; and
a hooking member which is interlocked with the action of the driving force transmitting member and hooks the tape guide member after the arm member is rotated to a position where the tape path is formed.

2. The magnetic recording/reproducing device according to claim 1, wherein the hooking member is arranged to hook the tape guide member at the position where the tape path is formed, when the arm member is rotated from a tape guide member side to a return direction side.

3. The magnetic recording/reproducing device according to claim 1, further comprising:
a positioning member which is brought in contact with the arm member when the arm member is rotated to the position where the tape path is formed; and
a pressing member which presses the arm member to the positioning member in accordance with a sliding operation of the driving force transmitting member after the arm member contacts the positioning member.

4. The magnetic recording/reproducing device according to claim 1, wherein a location in a rotation direction of the arm member and a location in a vertical direction of the arm member are determined when the arm member is rotated to the position where the tape path is formed.
